(19) United States
(12) Patent Application Publication
(10) Pub. No.: US 2014/0152634 A1
(43) Pub. Date: Jun. 5, 2014

(54) DISPLAY DEVICE, DRIVE DEVICE, AND DRIVE METHOD

(71) Applicants: Yoshinori Shibata, Osaka (JP); Masami Ozaki, Osaka (JP); Kohji Saitoh, Osaka (JP); Masaki Uehata, Osaka (JP); Kazuki Takahashi, Osaka (JP); Jun Nakata, Osaka (JP)

(72) Inventors: Yoshinori Shibata, Osaka (JP); Masami Ozaki, Osaka (JP); Kohji Saitoh, Osaka (JP); Masaki Uehata, Osaka (JP); Kazuki Takahashi, Osaka (JP); Jun Nakata, Osaka (JP)

(73) Assignee: Sharp Kabushiki Kaisha, Osaka (JP)

(21) Appl. No.: 14/001,300

(22) PCT Filed: Feb. 21, 2012
(86) PCT No.: PCT/JP2012/054134

§ 371 Date: Aug. 23, 2013

(30) Foreign Application Priority Data
Feb. 28, 2011 (JP) 2011-043131

(51) Int. Cl. G09G 3/36

(52) U.S. Cl. CPC G09G 3/3614
USPC 345/209; 345/96

(57) ABSTRACT

The objective of the present invention is to suppress the occurrence of flickering and to reduce the power consumption of a display device. A liquid crystal display device that is an embodiment of the present invention splits one frame into a plurality of fields and performs interlaced driving, and has a timing controller that, with a predetermined number of selected pixels in the direction of a scanning line and a signal line as units, is for reversing the polarity of a data signal applied to selected pixels in a field in a manner so that there is the same number of positive and negative polarities of the data signal applied to the selected pixels disposed along a signal line, and is for reversing the polarity in a manner such that the polarity of the data signal applied to the selected pixels changes for each frame.

### TECHNICAL FIELD

The present invention relates to a display device that conducts the interlaced driving, a drive device, and a driving method.

### BACKGROUND ART

In recent years, technologies to reduce power consumption in liquid crystal display devices have been developed rapidly. A reduction in power consumption is a critical issue in liquid crystal display devices that are used in portable devices such as mobile phones, smartphones, or laptop computers, in particular.

One of known technologies to reduce power consumption is the interlaced driving in which scan lines provided in a display part are scanned (selected) every other line or every few lines, thereby constituting one screen of a plurality of frames.

Patent Document 1 discloses a technology in which interlaced driving and non-interlaced driving are switched to one another depending on whether the display image is a moving image or still image, and in the interlaced driving, scan lines are scanned every “j” lines in order of the k-th line, the k+(j+1)-th line, the k+2(j+1)-th line, . . . in the i-th frame, and in the i+1-th frame, scan lines are scanned every “j” lines in order of the k+1-th line, the k+1+(j+1)-th line, the k+1+2(j+1)-th line, . . . , thereby constituting one screen of the total of j+1 frames.

FIG. 28 is a timing chart for the case in which scan lines are alternately scanned (j=1) in a planar display device disclosed in Patent Document 1, thereby constituting one screen of a total of two frames.

In the interlaced driving, as shown in FIG. 28, first, in the i-th frame, odd scan lines are scanned such as the first line, the third line, and the fifth line. Next, in the i+1 frame, even scan lines are scanned such as the second line, the fourth line, and the sixth line. By the scanning in the i-th frame and the i+1 frame, all of the scan lines are scanned, thereby creating one image.

As described above, in the interlaced driving, by scanning every other or every few scan lines alternately, power consumption can be reduced.

Many liquid crystal display devices employ a driving method that is referred to as polarity reverse driving to prevent pixel burn-in. In the polarity reverse driving, the polarity of a data signal to be applied to each pixel in one frame is made opposite to the polarity of a data signal that was applied to each corresponding pixel in the preceding frame, thereby preventing burn-in of the pixels. Specific known examples of the polarity reverse driving include frame reverse driving in which data signals of the same polarity are applied in the entire frame, horizontal line reverse driving in which polarities of data signals are made opposite to each other between two adjacent horizontal lines, vertical line reverse driving in which polarities of data signals are made opposite to each other between two adjacent vertical lines, and dot reverse driving in which polarities of data signals are made opposite to each other between two adjacent pixels.

In the frame reverse driving, because the data signals of the same polarity are applied in the entire frame, flickering is likely to occur in the entire frame. In the horizontal line reverse driving, because each horizontal line receives the data signal of the same polarity, flickering is likely to occur along the horizontal line. In the vertical line reverse driving, because each vertical line receives the data signal of the same polarity, flickering is likely to occur along the vertical line. On the other hand, in the dot reverse driving, because polarities of data signals are made opposite to each other between two adjacent pixels, the flickering is less likely to occur as compared with the three polarity reverse methods described above.

### RELATED ART DOCUMENT

### Patent Document

Patent Document 1: Japanese Patent Application Laid-Open Publication, “Japanese Patent Application Laid-Open Publication No. 2006-64964 (Published on Mar. 9, 2006)”

### SUMMARY OF THE INVENTION

### Problems to be Solved by the Invention

In order to achieve a liquid crystal display device with low power consumption while mitigating the occurrence of flickering, one may consider combining the dot reverse driving and the interlaced driving. However, the inventors of the present invention discovered that simply combining the two would worsen the flickering.

This problem will be explained with reference to FIG. 29. FIG. 29 is a diagram showing an example of polarities of data signals applied to respective pixels in one frame when the dot reverse driving and the interlaced driving are simply combined. In FIG. 29, pixels along the scan lines that are not scanned (non-selected scan lines) are shaded. As shown in FIG. 29, when the dot reverse driving and the interlaced driving are simply combined, each vertical line receives data signals of the same polarity. This causes flickering to occur along the vertical lines.

The present invention was made to solve the above-mentioned problem, based on the findings of the inventors of the present invention, and a main object thereof is to provide a display device that can suppress the occurrence of flickering while keeping power consumption low.

### Means for Solving the Problems

In order to solve the above-mentioned problem, a display device according to an embodiment of the present invention includes: a display panel including a plurality of gate lines, a plurality of data lines disposed to intersect with the plurality of gate lines, and a plurality of pixels disposed for respective intersections of the plurality of gate lines and the plurality of data lines; a gate line driver circuit that supplies gate signals to the plurality of gate lines; a data line driver circuit that supplies data signals to the plurality of data lines; and a controller that controls the gate signals and the data signals by using an interlaced driving method in which one frame is constituted of a plurality of fields, wherein the controller causes polarities of data signals applied to selected pixels that are to be selected in one field to be reversed every prescribed number of the pixels to be selected in a direction along the gate lines and to be reversed every prescribed number of the pixels to be selected in a direction along the data lines, respectively, and wherein, in that one field, the controller also causes the polarity of data signal applied to each pixel to be selected to be opposite to the polarity of the data signal that was applied to the pixel to be selected in an immediately preceding field to that one field, the immediately preceding field being where the pixel to be selected was selected.

With this configuration, the controller controls the gate line driver circuit and the data line driver circuit such that the gate signals and the data signals are supplied by using interlaced driving method in which one frame is constituted of a plurality of fields. Therefore, with this configuration, power consumption can be reduced as compared with a configuration that does not use the interlaced driving method.

The controller controls the data line driver circuit such that the polarities of data signals applied to selected pixels that are to be selected in one field are reversed every prescribed number of the selected pixels in a direction along the gate lines and every prescribed number of the selected pixels in a direction along the data lines, respectively. With this configuration, the occurrence of flickering can be suppressed.

The controller also controls the data line driver circuit such that the polarity of data signal applied to each pixel to be selected in one field is made opposite to the polarity of the data signal that was applied to the pixel to be selected in an immediately preceding field to that one field, the immediately preceding field being where the pixel to be selected was previously selected. With this configuration, burn-in of the pixels can be prevented.

As described above, with the above-mentioned configuration, it is possible to suppress the occurrence of flickering while keeping power consumption low.

The selected pixels refer to the pixels that are defined by gate lines that receive the gate signal in one field. For example, when using the interlaced driving method in which one frame is constituted of a total of two fields, which are the first field of applying the gate signal to the odd gate lines and the second field of applying the gate signal to the even gate lines, selected pixels that are selected in the first field refer to the pixels that are defined by the odd gate lines, and selected pixels that are selected in the second field refer to the pixels that are defined by the even gate lines.

When the prescribed number in the direction along the gate lines is NG, and the prescribed number in the direction along the data lines is ND, the controller causes the polarities of data signals to be reversed every group of NG×ND selected pixels. When NG=1 and ND=1, for example, the controller conducts dot reverse driving for every selected pixel in respective fields that constitute one frame. When NG=2 and ND=2, the controller conducts polarity reversal driving for every 2×2 selected pixel group in respective fields that constitute one frame.

In order to solve the above-mentioned problem, a drive device of a display device of an embodiment of the present invention is a drive device that drives a display panel including a plurality of gate lines, a plurality of data lines disposed to intersect with the plurality of gate lines, and a plurality of pixels disposed for respective intersections of the plurality of gate lines and the plurality of data lines, the drive device including: a gate line driver circuit that supplies gate signals to the plurality of gate lines; a data line driver circuit that supplies data signals to the plurality of data lines; and a controller that controls the gate signal and the data signals by using an interlaced driving method in which one frame is constituted of a plurality of fields, wherein the controller causes polarities of data signals applied to selected pixels that are to be selected in one field to be reversed every prescribed number of the pixels to be selected in a direction along the gate lines and to be reversed every prescribed number of the pixels to be selected in a direction along the data lines, respectively, and wherein, in that one field, the controller also causes the polarity of data signal applied to each pixel to be selected to be opposite to the polarity of the data signal that was applied to the pixel to be selected in an immediately preceding field to that one field, the immediately preceding field being where the pixel to be selected was selected.

With this configuration, the controller controls the gate line driver circuit and the data line driver circuit such that the gate signals and the data signals are supplied by using the interlaced driving method in which one frame is constituted of a plurality of fields. Therefore, with this configuration, power consumption can be reduced as compared with a configuration that does not use the interlaced driving method.

The controller controls the data line driver circuit such that the polarities of data signals applied to selected pixels that are to be selected in one field are reversed every prescribed number of the selected pixels in a direction along the gate lines and every prescribed number of the selected pixels in a direction along the data lines, respectively. With this configuration, the occurrence of flickering can be suppressed.

The controller controls the data line driver circuit such that the polarity of data signal applied to each pixel to be selected in one field is made opposite to the polarity of the data signal that was applied to the pixel to be selected in an immediately preceding field to that one field, the immediately preceding field being where the pixel to be selected was previously selected. With this configuration, burn-in of the pixels can be prevented.

As described above, with the above-mentioned configuration, it is possible to suppress the occurrence of flickering while keeping power consumption low.

The selected pixels refer to the pixels that are defined by gate lines that receive the gate signal in one field. For example, when using the interlaced driving method in which one frame is constituted of a total of two fields, which are the first field of applying the gate signal to the odd gate lines and the second field of applying the gate signal to the even gate lines, selected pixels that are selected in the first field refer to the pixels that are defined by the odd gate lines, and selected pixels that are selected in the second field refer to the pixels that are defined by the even gate lines.

When the prescribed number in the direction along the gate lines is NG, and the prescribed number in the direction along the data lines is ND, the controller causes the polarities of data signals to be reversed every group of NG×ND selected pixels. When NG=1 and ND=1, for example, the controller conducts dot reverse driving for every selected pixel in respective fields that constitute one frame. When NG=2 and ND=2, the controller conducts polarity reversal driving for every 2×2 selected pixel group in respective fields that constitute one frame.

In order to solve the above-mentioned problem, a driving method for a display device of an embodiment of the present invention is a driving method for driving a display panel including a plurality of gate lines, a plurality of data lines disposed to intersect with the plurality of gate lines, and a plurality of pixels disposed for respective intersections of the plurality of gate lines and the plurality of data lines, by using an interlaced driving method in which one frame is constituted of a plurality of fields, the method including: causing polarities of data signals applied to selected pixels that are to be selected in one field to be reversed every prescribed number of the pixels to be selected in a direction along the gate lines and to be reversed every prescribed number of the pixels to be selected in a direction along the data lines, respectively, and causing, in that one field, the polarity of data signal applied to each pixel to be selected to be opposite to the polarity of the data signal that was applied to the pixel to be selected in an immediately preceding field to that one field, the immediately preceding field being where the pixel to be selected was selected.

In this driving method, the gate signals and the data signals are controlled to be supplied by using the interlaced driving method in which one frame is constituted of a plurality of frames. Therefore, with the above-mentioned driving method, power consumption can be reduced as compared with a configuration that does not use the interlaced driving method.

With the above-mentioned driving method, the polarities of data signals applied to selected pixels that are to be selected in one field are reversed every prescribed number of the selected pixels in a direction along the gate lines and every prescribed number of the selected pixels in a direction along the data lines, respectively. With this driving method, the occurrence of flickering can be suppressed.

With the above-mentioned driving method, the polarity of data signal applied to each pixel that is to be selected in one field is made opposite to the polarity of the data signal that was applied to the pixel in an immediately preceding field to that one field, the immediately preceding field being where the pixel to be selected was previously selected. With this configuration, burn-in of the pixels can be prevented.

As described above, with this driving method, it is possible to suppress the occurrence of flickering while keeping power consumption low.

### Effects of the Invention

A display device according to an embodiment of the present invention includes: a display panel including a plurality of gate lines, a plurality of data lines disposed to intersect with the plurality of gate lines, and a plurality of pixels disposed for respective intersections of the plurality of gate lines and the plurality of data lines; a gate line driver circuit that supplies gate signals to the plurality of gate lines; a data line driver circuit that supplies data signals to the plurality of data lines; and a controller that controls the gate signals and the data signals by using an interlaced driving method in which one frame is constituted of a plurality of fields, wherein the controller causes polarities of data signals applied to selected pixels that are to be selected in one field to be reversed every prescribed number of the pixels to be selected in a direction along the gate lines and to be reversed every prescribed number of the pixels to be selected in a direction along the data lines, respectively, and wherein, in that one field, the controller also causes the polarity of data signal applied to each pixel to be selected to be opposite to the polarity of the data signal that was applied to the pixel to be selected in an immediately preceding field to that one field, the immediately preceding field being where the pixel to be selected was selected.

This makes it possible to suppress the occurrence of flickering while keeping the power consumption low.

### BRIEF DESCRIPTION OF THE DRAWINGS

FIG. 1 is a diagram showing an overall configuration of a liquid crystal display device of one embodiment of the present invention.

FIG. 2 is a diagram showing an arrangement of subpixels that constitute main pixels provided in a display panel of the liquid crystal display device shown in FIG. 1.

FIG. 3 is a transition diagram schematically showing changes in polarities of respective subpixels when conducting one-line interlaced driving and one-dot reverse driving in the liquid crystal display device of one embodiment of the present invention.

FIG. 4 is a timing chart that shows a relationship between a scan signal and a data signal.

FIG. 5 is a transition diagram schematically showing changes in polarities of respective subpixels when conducting one-line interlaced driving and one-dot reverse driving in the liquid crystal display device of one embodiment of the present invention.

FIG. 6 is a transition diagram schematically showing changes in polarities of respective subpixels when conducting one-line interlaced driving and two-dot reverse driving in the liquid crystal display device of one embodiment of the present invention.

FIG. 7 is a transition diagram schematically showing changes in polarities of respective subpixels when conducting two-line interlaced driving and two-dot reverse driving in the liquid crystal display device of one embodiment of the present invention.

FIG. 8 is a transition diagram schematically showing changes in polarities of respective subpixels when conducting two-line interlaced driving and two-dot reverse driving in the liquid crystal display device of one embodiment of the present invention.

FIG. 9 is a transition diagram schematically showing changes in polarities of respective subpixels when conducting two-line interlaced driving and two-dot reverse driving in the liquid crystal display device of one embodiment of the present invention.

FIG. 10 is a diagram showing an arrangement of four subpixels that constitute a main pixel in a display panel of a liquid crystal display device of another embodiment of the present invention.

FIG. 11 is a transition diagram schematically showing changes in polarities of respective subpixels when conducting one-line interlaced driving and one-dot reverse driving in the liquid crystal display device of another embodiment of the present invention.

FIG. 12 is a transition diagram schematically showing changes in polarities of respective subpixels when conducting one-line interlaced driving and two-dot reverse driving in the liquid crystal display device of another embodiment of the present invention.

FIG. 13 is a transition diagram schematically showing changes in polarities of respective subpixels when conducting two-line interlaced driving and one-dot reverse driving in the liquid crystal display device of another embodiment of the present invention.

FIG. 14 is a transition diagram schematically showing changes in polarities of respective subpixels when conducting two-line interlaced driving and two-dot reverse driving in the liquid crystal display device of another embodiment of the present invention.

FIG. 15 is a transition diagram schematically showing changes in polarities of respective subpixels when conducting two-line interlaced driving and two-dot reverse driving in the liquid crystal display device of another embodiment of the present invention.

FIG. 16 is a diagram showing an arrangement of three subpixels that constitute a main pixel in a display panel of a liquid crystal display device of yet another embodiment of the present invention.

FIG. 17 is a transition diagram schematically showing changes in polarities of respective subpixels when conducting one-line interlaced driving and one-dot reverse driving in the liquid crystal display device of yet another embodiment of the present invention.

FIG. 18 is a transition diagram schematically showing changes in polarities of respective subpixels when conducting one-line interlaced driving and two-dot reverse driving in the liquid crystal display device of yet another embodiment of the present invention.

FIG. 19 is a transition diagram schematically showing changes in polarities of respective subpixels when conducting two-line interlaced driving and one-dot reverse driving in the liquid crystal display device of yet another embodiment of the present invention.

FIG. 20 is a transition diagram schematically showing changes in polarities of respective subpixels when conducting two-line interlaced driving and two-dot reverse driving in the liquid crystal display device of yet another embodiment of the present invention.

FIG. 21 is a transition diagram schematically showing changes in polarities of respective subpixels when conducting two-line interlaced driving and two-dot reverse driving in the liquid crystal display device of yet another embodiment of the present invention.

FIG. 22 is a diagram showing an arrangement of two subpixels that constitute a main pixel in a display panel of a liquid crystal display device of yet another embodiment of the present invention.

FIG. 23 is a diagram showing an arrangement of three subpixels that constitute a main pixel in a display panel of a liquid crystal display device of yet another embodiment of the present invention.

FIG. 24 is a transition diagram schematically showing changes in polarities of respective subpixels when conducting one-line interlaced driving and one-dot reverse driving in the liquid crystal display device of yet another embodiment of the present invention.

FIG. 25 is a transition diagram schematically showing changes in polarities of respective subpixels when conducting one-line interlaced driving and three-dot reverse driving in the liquid crystal display device of yet another embodiment of the present invention.

FIG. 26 is a transition diagram schematically showing changes in polarities of respective subpixels when conducting three-line interlaced driving and one-dot reverse driving in the liquid crystal display device of yet another embodiment of the present invention.

FIG. 27 is a transition diagram schematically showing changes in polarities of respective subpixels when conducting three-line interlaced driving and three-dot reverse driving in the liquid crystal display device of yet another embodiment of the present invention.

FIG. 28 shows a timing chart for the case of scanning every other scan line in a planar display device disclosed in Patent Document 1, thereby creating one image with two frames.

FIG. 29 is a diagram showing an example of polarities of data signals applied to respective pixels in one frame when the dot reverse driving and the interlaced driving are simply combined.

FIG. 30 is a transition diagram schematically showing changes in polarities of respective subpixels when conducting one-line interlaced driving and m-dot reverse driving in the liquid crystal display device of one embodiment of the present invention.

### DETAILED DESCRIPTION OF EMBODIMENTS

### Embodiment 1

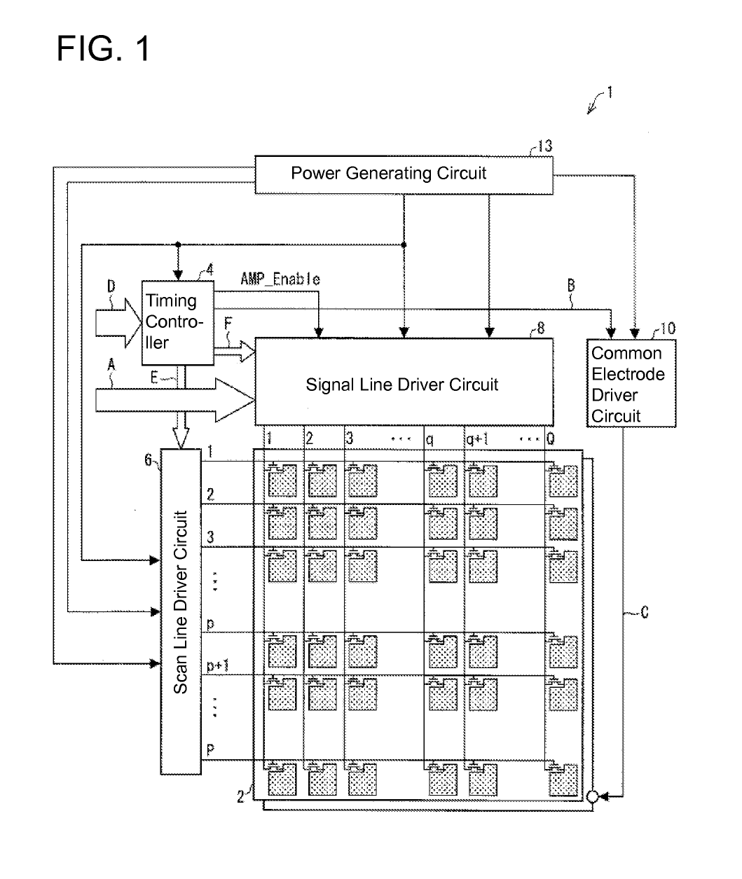

A display device according to an embodiment of the present invention will be described with reference to FIGS. 1 to 9. However, the configurations described in the embodiment below are merely examples, and are not limiting the scope of the present invention, unless otherwise specifically noted.

In the present embodiment, an example in which the display device is a liquid crystal display device equipped with a liquid crystal display (LCD) as a display panel will be described, but the present invention is not limited thereto. The display device of the present invention may be a PDP display device equipped with a plasma display (PD), an EL display device equipped with an EL display, or the like.

(Configuration of Liquid Crystal Display Device)

First, a configuration of a liquid crystal display device 1 of the present embodiment will be explained with reference to FIG. 1. FIG. 1 is a diagram showing an overall configuration of the liquid crystal display device 1 of Embodiment 1.

As shown in FIG. 1, the liquid crystal display device 1 includes a display panel (liquid crystal display panel) 2, a timing controller 4 (controller), a scan line driver circuit 6 (gate line driver circuit), a signal line driver circuit 8 (data line driver circuit), a common electrode driver circuit 10, and a power generating circuit 13.

The display panel 2 includes P rows (P is an integer of 1 or greater) of scan lines (gate lines), Q columns (Q is an integer of 1 or greater) of data signal lines disposed to intersect with the scan lines, and a plurality of subpixels provided for respective intersections of the scan lines and the data signal lines. As described below, a prescribed number of subpixels group together and constitute a main pixel (picture element).

The timing controller 4 obtains synchronizing signals and gate clock signals sent from the outside (arrow D), and outputs, to respective circuits in the liquid crystal display device 1, reference signals for allowing the respective circuits to operate in synchronization with each other. Specifically, the timing controller 4 supplies a gate start pulse signal, a gate clock signal GCK, and a gate output control signal GOE to the scan line driver circuit 6 (arrow E). The timing controller 4 outputs a source start pulse signal, a source latch strobe signal, a source clock signal, and a polarity reverse signal to the signal line driver circuit 8 (arrow F).

The timing controller 4 controls the operations of the scan line driver circuit 6 and the signal line driver circuit 8, thereby driving the liquid crystal display device 1 with the interlaced driving method in which one frame is made of a plurality of fields.

Specifically, the timing controller 4 uses the gate output control signal GOE to control a timing for the scan line driver circuit 6 to scan (select) the scan lines. The timing controller 4 uses the polarity reverse signal to control the polarity of data signals supplied from the signal line driver circuit 8.

The scan line driver circuit 6 starts scanning the scan lines when receiving the gate start pulse signal sent from the timing controller 4. When the scanning starts, the scan line driver circuit 6 applies a select voltage to respective scan lines from the scan line of the first row of the display panel 2 toward the bottom, based on the gate clock signal GCK and the gate output control signal GOE sent from the timing controller 4. The scan line driver circuit 6 supplies, to respective scan lines, a scan signal (gate signal) that is a voltage for turning on switching elements (TFTs) provided in respective subpixels on each scan line, from top to bottom. In this manner, the scan line driver circuit 6 selects and scans the respective scan lines from top to bottom. “Supplying the scan signal that is a voltage for turning on the switching elements,” will also be referred to as “scanning the scan lines” below.

Specifically, the scan line driver circuit 6 selects the scan lines line by line, from top to bottom, in accordance with the received gate clock GCK signal. When detecting the drop of the received gate output control signal GOE, the scan line driver circuit 6 applies a select voltage to the scan line to be selected. In this manner, the scan line driver circuit 6 scans the scan lines to be selected. The scan line driver circuit 6 is also capable of the interlaced driving as described below.

Based on the source start pulse signal received from the timing controller 4, the signal line driver circuit 8 stores inputted image data for the respective subpixels into a register in accordance with the source clock signal. The signal line driver circuit 8 supplies a data signal, which is the image data, to each data signal line in the display panel 2 according to the source latch strobe signal provided next, thereby charging a pixel electrode provided in a subpixel that includes each data signal line.

Specifically, the signal line driver circuit 8 calculates a voltage value to be outputted to each subpixel on the selected scan line, based on the inputted image signal (arrow A), and outputs a voltage corresponding to the value to each data signal line. As a result, the image data is supplied to each subpixel on the selected scan line.

Furthermore, based on the polarity reverse signal received from the timing controller 4, the signal line driver circuit 8 causes the polarities of data signals applied to selected pixels, which are subpixels to be selected in one field, to be reversed for every prescribed number of selected pixels in the row direction and every prescribed number of selected pixels in the column direction, respectively, and also causes the polarity of data signal applied to each pixel to be selected in one field to be opposite to the polarity of the data signal that was applied to the pixel in an immediately preceding field to that one field, the immediately preceding field being where the pixel to be selected was previously selected.

The power generating circuit 13 generates a voltage necessary for each circuit in the liquid crystal display device 1 to operate. The power generating circuit 13 outputs the generated voltage to the scan line driver circuit 6, the signal line driver circuit 8, the timing controller 4, and the common electrode driver circuit 10.

The liquid crystal display device 1 includes a common electrode (not shown) disposed to face the respective subpixels in the display panel 2. The common electrode driver circuit 10 outputs to the common electrode a prescribed common voltage for driving the common electrode (arrow C), based on a signal (arrow B) sent from the timing controller 4.

(Configuration of Main Pixel)

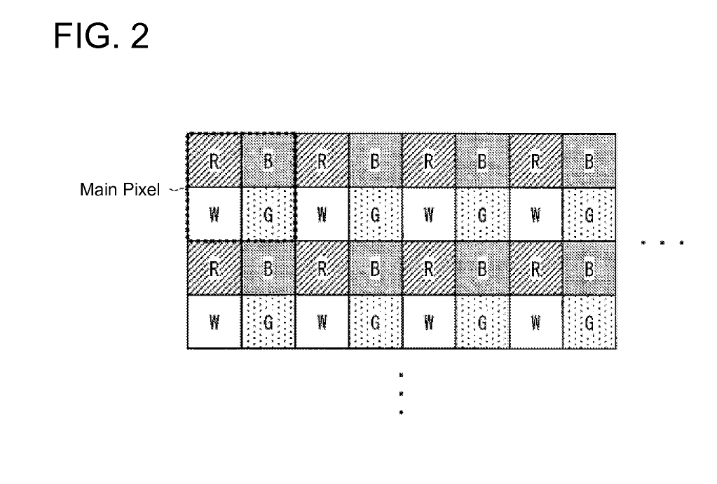

Next, with reference to FIG. 2, the arrangement of subpixels constituting main pixels in the display panel 2 of the liquid crystal display device 1 of the present embodiment will be explained. FIG. 2 is a diagram showing an arrangement of subpixels that constitute main pixels provided in the display panel 2 of the liquid crystal display device 1 of the present embodiment.

As shown in FIG. 2, one main pixel (picture element) is made of four subpixels, which include three subpixels that respectively display three primary colors (subpixel R displaying red, subpixel B displaying blue, and subpixel G displaying green), and a subpixel that displays one color that is obtained by combining at least one of the three primary colors (subpixel W displaying white). These four subpixels are arranged such that two are aligned in the row direction and two are aligned in the column direction, respectively, and as shown in FIG. 2, for example, the subpixel R and the subpixel B, and the subpixel W and the subpixel G are respectively adjacent to each other along the row direction, and the subpixel R and the subpixel W, and the subpixel B and the subpixel G are respectively adjacent to each other along the column direction.

In the present embodiment, an example in which the subpixel R and the subpixel B, and the subpixel W and the subpixel G are respectively adjacent to each other along the row direction, and the subpixel R and the subpixel W, and the subpixel B and the subpixel G are respectively adjacent to each other along the column direction is described, but the present invention is not limited thereto. The four subpixels can be arranged in 24 different ways, which is the factorial of four, and for example, the four subpixels may be arranged such that the subpixel R and the subpixel G, and the subpixel W and the subpixel B are respectively adjacent to each other along the row direction, and the subpixel R and the subpixel W, and the subpixel G and the subpixel B are respectively adjacent to each other along the column direction.

In the present embodiment, an example in which the four subpixels include the subpixel W displaying white as the one color that is obtained by combining at least one of the three primary colors is described, but the present invention is not limited thereto. For example, instead of the subpixel W displaying white, a subpixel Y displaying yellow, a subpixel displaying only one color of the three primary colors (one of red, blue, and green), or a subpixel displaying another color may also be used.

(Interlaced Driving)

When conducting the interlaced driving, one frame is divided into each unit that is referred to as a field (scan lines that are scanned in one frame are divided into a plurality of groups each of which is scanned in one field), and the scanning is performed for each field.

For example, when one frame is divided into two fields, in one field (also referred to as the first field below), the scan line driver circuit 6 scans the scan lines alternately by supplying the scan signal to every other scan line. In the next field (also referred to as the second field below), the scan lines that were not scanned in the first field are scanned. That is, if the first field is constituted by scanning the scan lines of odd rows, the second field is constituted by scanning the scan lines of even rows.

In the present embodiment, the first field and the second field may be configured such that scan lines of two rows are skipped in each field, in addition to the configuration in which every other scan line is skipped in the scanning.

Alternatively, the interlaced driving method of the present embodiment may be configured such that the interlaced driving is conducted by scanning every “j” scan line in order of the k-th line, the k+(j+1)-th line, the k+2(j+1)-th line, . . . in the i-th field, and by scanning every “j” scan line in order of the k+1-th line, the k+1+(j+1)-th line, the k+1+2(j+1)-th line, . . . in the i+1-th field, thus constituting one frame of a total of j+1 fields.

(One-Line Interlaced Driving, One-Dot Reverse Driving)

Described below is the case in which the scan line driver circuit 6 scans (selects) every “n” row (n is an integer of 1 or greater) by the interlaced driving, while the signal line driver circuit 8 causes the polarities of data signals, which are to be supplied to selected scan lines, to be reversed every “m” row (m is an integer of 1 or greater) of selected scan lines. In the present embodiment, the “m” dot reverse driving will be explained as an example of the driving method in which the polarities are reversed every “m” row of the selected scan lines. However, the present invention is not limited thereto.

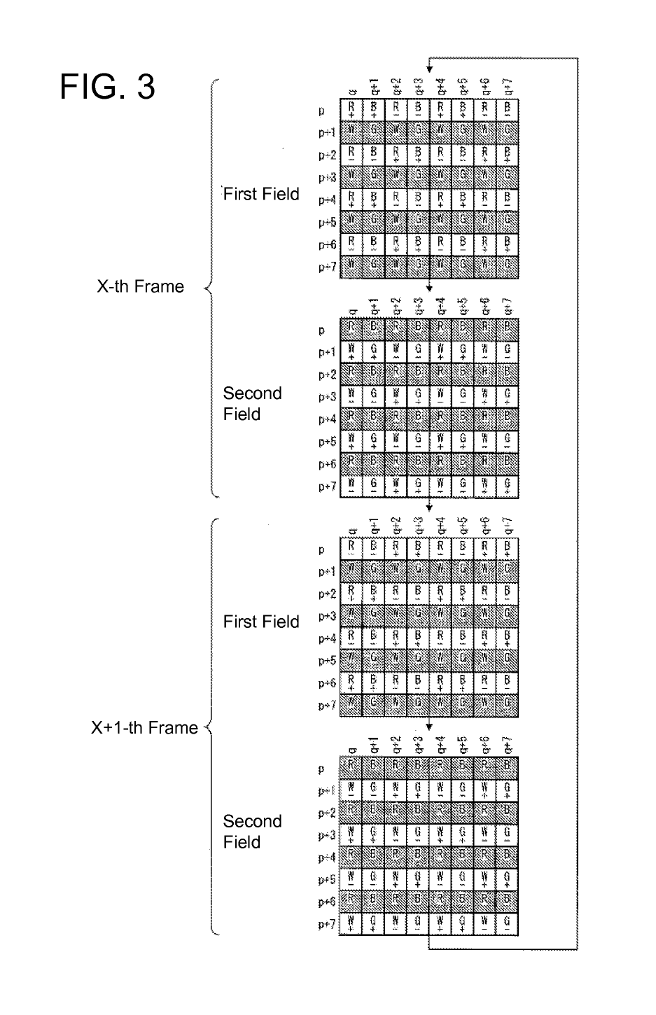

First, the case in which the one-line interlaced driving (n=1) and the one-dot reverse driving (m=1) are conducted will be explained with reference to FIG. 3. FIG. 3 is a transition diagram schematically showing changes in polarities of respective subpixels in the liquid crystal display device 1 of the present embodiment.

As shown in FIG. 3, in the one-line interlaced driving of the present embodiment, the first field is constituted by scanning the scan line of the p-th row (1≦p≦P−11), the scan line of the p+2-th row, the scan line of the p+4-th row, and the scan line of the p+6-th row. The second field is constituted by scanning the scan line of the p+1-th row, the scan line of the p+3-th row, the scan line of the p+5-th row, and the scan line of the p+7-th row. That is, the first field and the second field are constituted by scanning every other scan line.

(First Field of x-th Frame)

As shown in FIG. 3, in the first field of the x-th frame, the scan line driver circuit 6 scans the scan line of the p-th row, the scan line of the p+2-th row, the scan line of the p+4-th row, and the scan line of the p+6-th row from top to bottom. At this time, the scan line of the p+1-th row, the scan line of the p+3-th row, the scan line of the p+5-th row, and the scan line of the p+7-th row, which are scan lines for the second field, are skipped. In this manner, the scan line driver circuit 6 scans every second scan line from the scan line of the first row to the scan line of the P-th row.

As shown in FIG. 3, in the first field of the x-th frame, when the scan line driver circuit 6 scans the scan line of the p-th row, the signal line driver circuit 8 supplies a data signal having the “+” polarity to the data signal line of the q-th column (1≦q≦Q−15), and supplies a data signal having the “+” polarity to the data signal line of the q+1-th column. Furthermore, the signal line driver circuit 8 supplies data signals having the “−” polarity to the data signal lines of the q+2-th column and q+3-th column, supplies data signals having the “+” polarity to the data signal lines of the q+4-th column and q+5-th column, and supplies data signals having the “−” polarity to the data signal lines of the q+6-th column and q+7-th column.

In the present embodiment, as described above, when the scan line driver circuit 6 scans the scan line of the p-th row, the signal line driver circuit 8 supplies data signals of the same polarity to each pair of subpixels aligned along the row direction and included in the same main pixel, which is indicated with the broken line in FIG. 2, from the data signal line of the first column to the data signal line of the Q-th column. In other words, along the row direction, the polarities of the data signals to be applied to the respective subpixels are reversed every pair of subpixels aligned along the row direction and included in the same main pixel.

In the first field of the x-th frame, when the scan line driver circuit 6 scans the scan line of the p+2-th row, the signal line driver circuit 8 supplies a data signal having the “−” polarity to the data signal line of the q-th column, and supplies a data signal having the “−” polarity to the data signal line of the q+1-th column. Furthermore, the signal line driver circuit 8 supplies data signals having the “+” polarity to the data signal lines of the q+2-th column and q+3-th column, supplies data signals having the “−” polarity to the data signal lines of the q+4-th column and q+5-th column, and supplies data signals having the “+” polarity to the data signal lines of the q+6-th column and q+7-th column.

As described above, when the scan line driver circuit 6 scans the scan line of the p+2-th row, the signal line driver circuit 8 is driven to supply data signals of the same polarity to each pair of subpixels aligned along the row direction and included in the same main pixel from the data signal line of the first column to the data signal line of the Q-th column.

By the scan line driver circuit 6 and the signal line driver circuit 8 being driven in the manner described above, the polarity of the data signal applied to the subpixel R that is defined by the scan line of the p-th row and the data signal line of the q-th column (also referred to as the (p, q)-th subpixel below) becomes “+” as shown in FIG. 3. The polarity of the data signals applied to the (p+2, q)-th subpixel R and the (p, q+2)-th subpixel R becomes “−” as shown in FIG. 3.

The polarity of the data signal applied to the (p, q+1)-th subpixel B becomes “+” as shown in FIG. 3. The polarity of the data signals applied to the (p+2, q+1)-th subpixel B and the (p, q+3)-th subpixel B becomes “−” as shown in FIG. 3.

Accordingly, in the present embodiment, the signal line driver circuit 8 applies data signals having the opposite polarities to respective subpixels that display the same color and that are closest to each other, out of the subpixels defined by the scan lines that are scanned in the first field.

In other words, the signal line driver circuit 8 causes the polarities of data signals applied to the respective selected pixels to be reversed every two subpixels constituting the same main pixel in the row direction and every subpixel in the column direction (or in other words, every 2×1 selected pixel group) with respect to the row direction and the column direction, respectively.

(Second Field of x-th Frame)

Next, as shown in FIG. 3, in the second field of the x-th frame, the scan line driver circuit 6 scans the scan line of the p+1-th row, the scan line of the p+3-th row, the scan line of the p+5-th row, and the scan line of the p+7-th row from top to bottom. At this time, the scan line of the p-th row, the scan line of the p+2-th row, the scan line of the p+4-th row, and the scan line of the p+6-th row, which are scan lines for the first field, are skipped. In this manner, the scan line driver circuit 6 scans every second scan line from the scan line of the first row to the scan line of the P-th row. As shown in FIG. 3, the scan line driver circuit 6 conducts the one-line interlaced driving by repeating the scanning for the scan lines of the first field and the scanning for the scan lines of the second field.

As shown in FIG. 3, in the second field of the x-th frame, when the scan line driver circuit 6 scans the scan line of the p+1-th row, the signal line driver circuit 8 supplies a data signal having the “+” polarity to the data signal line of the q-th column, and supplies a data signal having the “+” polarity to the data signal line of the q+1-th column. Furthermore, the signal line driver circuit 8 supplies data signals having the “−” polarity to the data signal lines of the q+2-th column and q+3-th column, supplies data signals having the “+” polarity to the data signal lines of the q+4-th column and q+5-th column, and supplies data signals having the “−” polarity to the data signal lines of the q+6-th column and q+7-th column.

Also, in the second field of the x-th frame, when the scan line driver circuit 6 scans the scan line of the p+3-th row, the signal line driver circuit 8 supplies a data signal having the “−” polarity to the data signal line of the q-th column, and supplies a data signal having the “−” polarity to the data signal line of the q+1-th column. Furthermore, the signal line driver circuit 8 supplies data signals having the “+” polarity to the data signal lines of the q+2-th column and q+3-th column, supplies data signals having the “−” polarity to the data signal lines of the q+4-th column and q+5-th column, and supplies data signals having the “+” polarity to the data signal lines of the q+6-th column and q+7-th column.

In the present embodiment, as described above, when the scan line driver circuit 6 scans the scan line of the p-th row, the signal line driver circuit 8 supplies data signals of the same polarity to each pair of subpixels aligned along the row direction from the data signal line of the first column to the data signal line of the Q-th column.

By the scan line driver circuit 6 and the signal line driver circuit 8 being driven in the manner described above, the polarity of the data signal applied to the (p+1, q)-th subpixel W becomes “+” as shown in FIG. 3. The polarity of the data signal applied to the (p+3, q)-th subpixel W and the (p+1, q+2)-th subpixel W becomes “−” as shown in FIG. 3.

The polarity of the data signal applied to the (p+1, q+1)-th subpixel G becomes “+” as shown in FIG. 3. The polarity of the data signals applied to the (p+3, q+1)-th subpixel B and the (p+1, q+3)-th subpixel B becomes “−” as shown in FIG. 3.

Accordingly, the signal line driver circuit 8 applies data signals having the opposite polarities to respective subpixels that display the same color and that are closest to each other, out of the subpixels defined by the scan lines that are scanned in the second field.

(First and Second Fields of x+1-th Frame)

As shown in FIG. 3, the polarities of the data signals to be applied to the respective subpixels in the first field of the x+1-th frame are opposite to the polarities of the data signals that were applied to the corresponding subpixels in the first field of the x-th frame. The polarities of the data signals to be applied to the respective subpixels in the second field of the x+1-th frame are opposite to the polarities of the data signals that were applied to the corresponding subpixels in the second field of the x-th frame.

As described above, the polarity of data signal to be applied to each pixel that is to be selected in one field is made opposite to the polarity of the data signal that was applied to the pixel in an immediately preceding field to that one field, the immediately preceding field being where the pixel to be selected was previously selected.

As described above, the scan line driver circuit 6 selects each scan line in every other field, and the signal line driver circuit 8 is driven to cause the polarities of the data signals supplied to the respective data signal lines to be made opposite between every frame.

(Timing for Scan Signal and Data Signal)

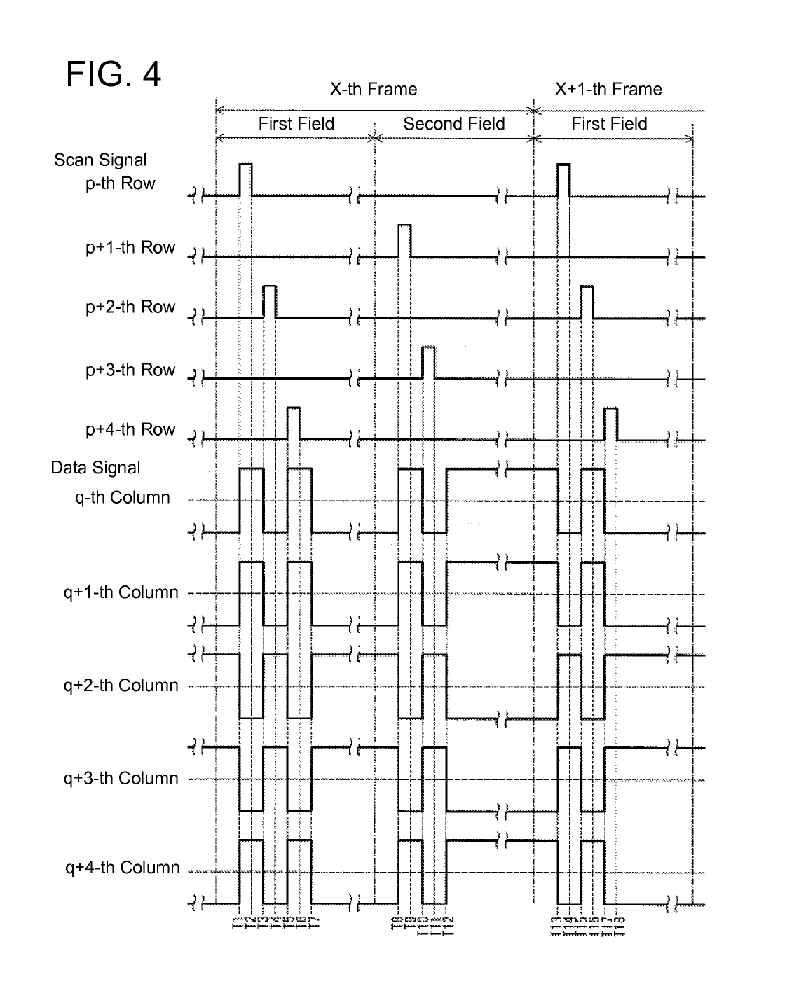

With reference to FIG. 4, timings of the scan signal and the data signal will be explained for the case in which the liquid crystal display device 1 of the present embodiment conducts the one-line interlaced driving and the one-dot reverse driving as shown in FIG. 3. FIG. 4 is a timing chart that shows a relationship between a scan signal and a data signal.

As shown in FIG. 4, in the first field of the x-th frame, almost at the same time as applying a scan signal of a high-level (H level) voltage to the scan line of the p-th row at time T1, data signals with the “+” polarity are supplied to the data signal lines of the q-th column, the q+1-th column, and the q+4-th column.

Also, almost at the same time as applying a scan signal of a high-level (H level) voltage to the scan line of the p-th row at time T1, data signals with the “−” polarity are supplied to the data signal lines of the q+2-th column and the q+3-th column. The potentials of these data signals are maintained after the supply of the scan signal of the H-level voltage to the scan line of the p-th row is stopped at time T2 until immediately before the scan signal of the H-level voltage is applied to the scan line of the p+2-th row at time T3.

Next, almost at the same time as applying the scan signal of the H-level voltage to the scan line of the p+2-th row at time T3, data signals with the “−” polarity are supplied to the data signal lines of the q-th column, the q+1-th column, and the q+4-th column, and data signals with the “+” polarity are supplied to the data signal lines of the q+2-th column and the q+3-th column. The potentials of these data signals are maintained after the supply of the scan signal of the H-level voltage to the scan line of the p+2-th row is stopped at time T4 until immediately before the scan signal of the H-level voltage is applied to the scan line of the p+4-th row at time T5.

Also, as shown in FIG. 4, in the second field of the x-th frame, almost at the same time as applying the scan signal of the H-level voltage to the scan line of the p+1-th row at time T8, data signals with the “+” polarity are supplied to the data signal lines of the q-th column, the q+1-th column, and the q+4-th column. Also, almost at the same time as applying the scan signal of the H-level voltage to the scan line of the p+1-th row at time T8, data signals with the “−” polarity are supplied to the data signal lines of the q+2-th column and the q+3-th column.

The potentials of these data signals are maintained after the supply of the scan signal of the H-level voltage to the scan line of the p+1-th row is stopped at T9 until immediately before the scan signal of the H-level voltage is applied to the scan line of the p+3-th row at time T10.

Next, almost at the same time as applying the scan signal of the H-level voltage to the scan line of the p+3-th row at time T10, data signals with the “−” polarity are supplied to the data signal lines of the q-th column, the q+1-th column, and the q+4-th column, and data signals with the “+” polarity are supplied to the data signal lines of the q+2-th column and the q+3-th column. The potentials of these data signals are maintained after the supply of the scan signal of the H-level voltage to the scan line of the p+3-th row is stopped at time T11 until immediately before the scan signal of the H-level voltage is applied to the scan line of the p+5-th row at time T12 (not shown).

Similarly, in the first field of the x-th frame, almost at the same time as applying the scan signal of the H-level voltage to the scan line of the p-th row at time T13, data signals with the “−” polarity are supplied to the data signal lines of the q-th column, the q+1-th column, and the q+4-th column, and the potentials of the data signals are maintained until immediately before the scan signal of the H-level voltage is applied to the scan line of the p+2-th row at time T15. Also, almost at the same time as applying the scan signal of the H-level voltage to the scan line of the p+2-th row at time T15, data signals with the “+” polarity are supplied to the data signal lines of the q-th column, the q+1-th column, and the q+4-th column, and the potentials of the data signals are maintained until immediately before the scan signal of the H-level voltage is applied to the scan line of the p+4-th row at time T15.

As described above, the timing controller 4 controls the scan line driver circuit 6 and the signal line driver circuit 8 so as to supply the scan signal and the data signal by using the interlaced driving method in which one frame is made of two fields.

The timing controller 4 controls the signal line driver circuit 8 such that the polarities of data signals are reversed every prescribed number of selected pixels, and the polarity of data signal applied to each pixel to be selected in one field is made opposite to the polarity of the data signal that was applied to the pixel in an immediately preceding field to the one field among previous fields where the pixel was selected. In this manner, the scan line driver circuit 6 and the signal line driver circuit 8 are driven such that the dot reverse driving is applied to gate lines selected by the interlaced driving.

With the above-mentioned configuration, the timing controller 4 controls the signal line driver circuit such that the polarities of data signals applied to the selected pixels in the first field (or the second field) of the x+1-th frame are reversed to those in the first field (or the second field) of the x-th frame.

As a result, it is possible to reduce the power consumption by the interlaced driving while suppressing the occurrence of flickering by the dot reverse driving.

In the present embodiment, the case in which, when the scan line driver circuit 6 and the signal line driver circuit 8 conduct the one-line interlaced driving and the one-dot reverse driving, with respect to the row direction, polarities of data signals to be applied to respective subpixels are reversed every two subpixels aligned along the row direction and included in the same main pixel was described as an example, but the present embodiment is not limited thereto. For example, the signal line driver circuit 8 may be configured such that, with respect to the row direction, data signals having different polarities are applied to two subpixels aligned along the row direction and included in the same main pixel, and the polarities of data signals applied to subpixels are reversed every two subpixels aligned along the row direction and included in respectively different main pixels adjacent to each other.

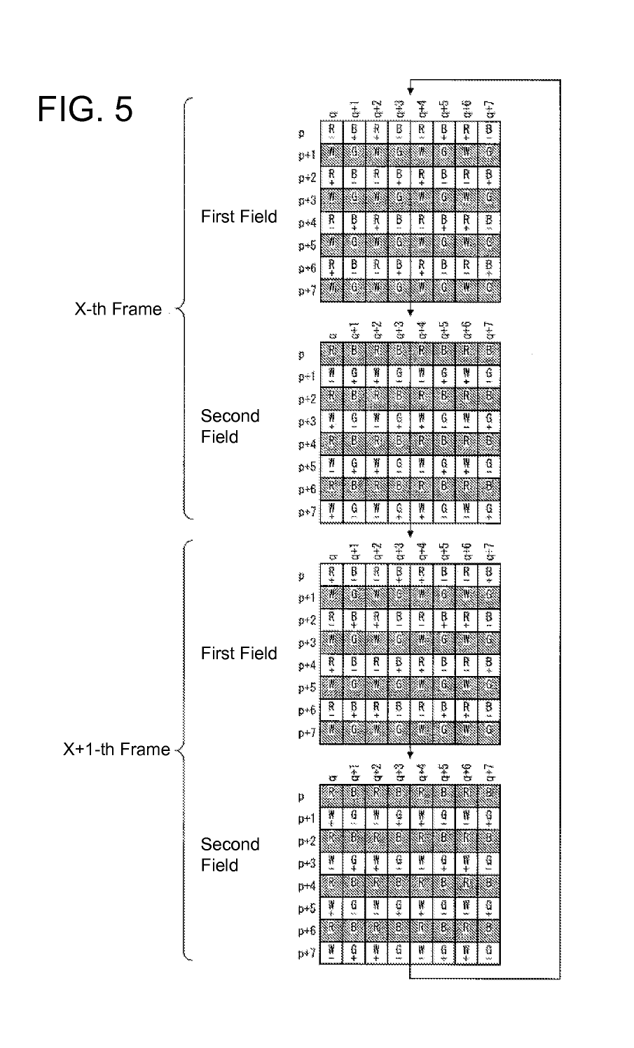

The driving method in which polarities of data signals to be applied to respective subpixels are reversed every two subpixels that are adjacent to each other along the row direction and that are included in different main pixels, respectively (every 2×1 selected pixel group), when conducting the one-dot reverse driving and the one-line interlaced driving will be explained with reference to FIG. 5. FIG. 5 is a transition diagram schematically showing changes in polarities of respective subpixels in the liquid crystal display device 1 of the present embodiment.

(x-th Frame)

As shown in FIG. 5, in the first field of the x-th frame, the scan line driver circuit 6 scans the scan line of the p-th row, the scan line of the p+2-th row, the scan line of the p+4-th row, and the scan line of the p+6-th row from top to bottom. At this time, the scan line of the p+1-th row, the scan line of the p+3-th row, the scan line of the p+5-th row, and the scan line of the p+7-th row, which are scan lines for the second field, are skipped.

In this manner, the scan line driver circuit 6 scans every second scan line from the scan line of the first row to the scan line of the P-th row, selecting each scan line in every other field.

At this time, the signal line driver circuit 8 applies data signals of the same polarity to two subpixels that are adjacent to each other and that are included in different main pixels, respectively. Also, the polarities of data signals to be applied to subpixels adjacent to each other in the column direction are reversed every subpixel, out of the subpixels defined by the scan lines that are scanned in each field.

By the scan line driver circuit 6 and the signal line driver circuit 8 being driven in the manner described above, the polarity of the data signals applied to the (p, q+1)-th subpixel B and the (p, q+2)-th subpixel R becomes “+” as shown in FIG. 5. The polarity of the data signals applied to the (p+2, q+1)-th subpixel B, the (p, q+3)-th subpixel B, the (p+2, q+2)-th subpixel R, and the (p, q+4)-th subpixel R becomes “−” as shown in FIG. 5.

(x+1-th Frame)

As shown in FIG. 5, the polarities of the data signals to be applied to the respective subpixels in the first field of the x+1-th frame are opposite to the polarities of the data signals that were applied to the corresponding subpixels in the first field of the x-th frame. The polarities of the data signals to be applied to the respective subpixels in the second field of the x+1-th frame are opposite to the polarities of the data signals that were applied to the corresponding subpixels in the second field of the x-th frame.

As described above, the polarity of data signal to be applied to each pixel that is to be selected in one field is made opposite to the polarity of the data signal that was applied to the pixel in an immediately preceding field to that one field, the immediately preceding field being where the pixel to be selected was previously selected.

As described above, the scan line driver circuit 6 selects each scan line in every other field, and the signal line driver circuit 8 is driven to cause the polarities of the data signals supplied to the respective data signal lines to be made opposite between every frame.

(One-Line Interlaced Driving, Two-Dot Reverse Driving)

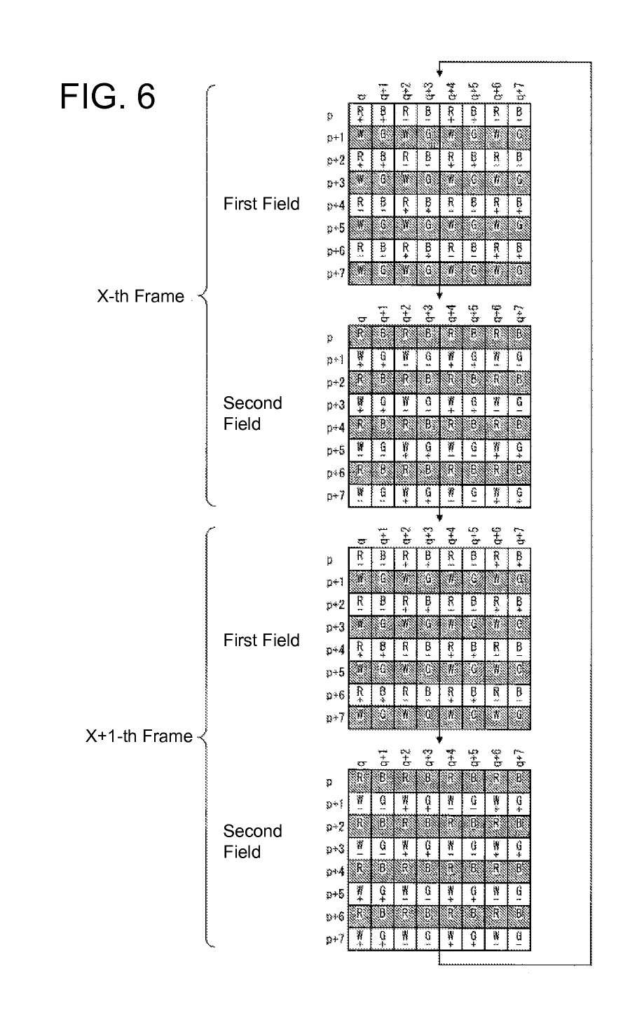

Next, the case in which the one-line interlaced driving (n=1) and the two-dot reverse driving (m=2) are conducted will be explained with reference to FIG. 6. FIG. 6 is a transition diagram schematically showing changes in polarities of respective subpixels when conducting one-line interlaced driving and two-dot reverse driving in the liquid crystal display device 1 of the present embodiment.

(x-th Frame)

As shown in FIG. 6, in the first field of the x-th frame, the scan line driver circuit 6 scans the scan line of the p-th row, the scan line of the p+2-th row, the scan line of the p+4-th row, and the scan line of the p+6-th row from top to bottom. The scan line driver circuit 6 skips the scan line of the p+1-th row, the scan line of the p+3-th row, the scan line of the p+5-th row, and the scan line of the p+7-th row, which are scan lines for the second field.

In this manner, the scan line driver circuit 6 scans every second scan line from the scan line of the first row to the scan line of the P-th row, selecting each scan line in every other field.

The signal line driver circuit 8 applies data signals of the same polarity to each pair of subpixels aligned along the row direction and included in the same main pixel. Also, the polarities of data signals to be applied to subpixels defined by the scan lines that are scanned in each field are reversed every subpixel disposed adjacent to each other in the column direction.

As described above, when the scan line driver circuit 6 scans the scan line, the signal line driver circuit 8 is driven to supply data signals of the same polarity to each pair of subpixels aligned along the row direction and included in the same main pixel, from the data signal line of the first column to the data signal line of the Q-th column.

By the scan line driver circuit 6 and the signal line driver circuit 8 being driven in the manner described above, the polarity of the data signals applied to the (p, q)-th subpixel R and the (p+2, q)-th subpixel R becomes “+” as shown in FIG. 6. The polarity of the data signals applied to the (p+4, q)-th subpixel R, the (p+6, q)-th subpixel R, the (p, q+2)-th subpixel R, and the (p+2, q+2)-th subpixel R becomes “−” as shown in FIG. 6.

Similarly, in the second field of the x-th frame, the polarity of the data signals applied to the (p+1, q)-th subpixel W and the (p+3, q)-th subpixel W becomes “+” as shown in FIG. 6. The polarity of the data signals applied to the (p+5, q)-th subpixel W, the (p+7, q)-th subpixel W, the (p+1, q+2)-th subpixel W, and the (p+3, q+2)-th subpixel W becomes “−” as shown in FIG. 6.

As described above, in the present embodiment, the signal line driver circuit 8 conducts the two-dot reverse driving such that the polarities of data signals are reversed every pair of subpixels that display the same color and that are closest to each other in the column direction, and such that respective two subpixels that display the same color and that are closest to each other in the row direction are applied with data signals of the opposite polarities, out of the subpixels defined by the scan lines scanned in the first field and the second field of the x-th frame.

That is, in each field, with respect to the row direction and the column direction, respectively, the signal line driver circuit 8 causes the polarities of data signals applied to the respective selected pixels to be reversed every two subpixels in the row direction, which constitute one main pixel, and every two subpixels in the column direction (or in other words, every 2×2 selected pixel group).

(x+1-th Frame)

As shown in FIG. 6, the polarities of the data signals to be applied to the respective subpixels in the first field of the x+1-th frame are opposite to the polarities of the data signals that were applied to the corresponding subpixels in the first field of the x-th frame. The polarities of the data signals to be applied to the respective subpixels in the second field of the x+1-th frame are opposite to the polarities of the data signals that were applied to the corresponding subpixels in the second field of the x-th frame.

As described above, the polarity of data signal to be applied to each pixel that is to be selected in one field is made opposite to the polarity of the data signal that was applied to the pixel in an immediately preceding field to that one field, the immediately preceding field being where the pixel to be selected was previously selected.

(Two-Line Interlaced Driving, Two-Dot Reverse Driving)

In the present embodiment, an example in which the one-line interlaced driving is conducted together with the one-dot reverse driving was described, but the present invention is not limited thereto. For example, it is possible to conduct the two-line interlaced driving (n=2) together with the two-dot reverse driving (m=2).

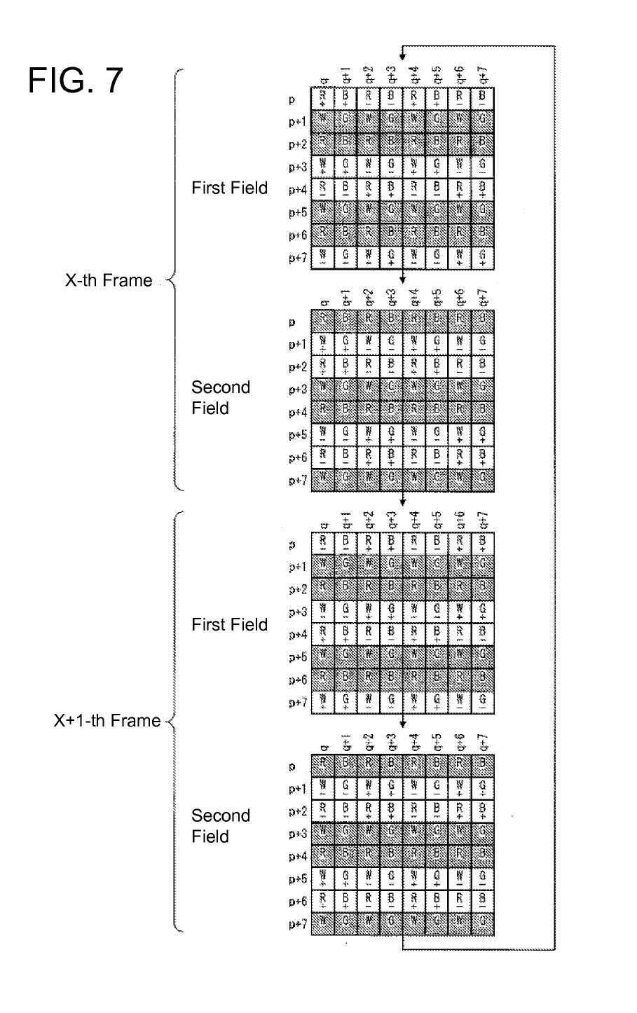

The case in which the two-line interlaced driving is conducted together with the two-dot reverse driving will be explained with reference to FIG. 7. FIG. 7 is a transition diagram schematically showing changes in polarities of respective subpixels when conducting two-line interlaced driving and two-dot reverse driving in the liquid crystal display device 1 of the present embodiment.

Because the two-line interlaced driving is conducted, as shown in FIG. 7, the first field is constituted by scanning the scan line of the p-th row, the scan line of the p+3-th row, the scan line of the p+4-th row, and the scan line of the p+7-th row. The second field is constituted by scanning the scan line of the p+1-th row, the scan line of the p+2-th row, the scan line of the p+5-th row, and the scan line of the p+6-th row. That is, the first field and the second field are constituted by scanning the scan lines, skipping two rows at a time.

(x-th Frame)

As shown in FIG. 7, in the first field of the x-th frame, the scan line driver circuit 6 scans the scan line of the p-th row, the scan line of the p+3-th row, the scan line of the p+4-th row, and the scan line of the p+7-th row from top to bottom. At this time, the scan line of the p+1-th row, the scan line of the p+2-th row, the scan line of the p+5-th row, and the scan line of the p+6-th row, which are scan lines for the second field, are skipped.

In this manner, the scan line driver circuit 6 scans the scan lines from the first row to the P-th row, while skipping one row at a time, thereby selecting each scan line in every other field.

The signal line driver circuit 8 applies data signals of the same polarity to each pair of subpixels aligned along the row direction and included in the same main pixel. Also, the polarities of data signals are reversed every two subpixels that are closest to each other in the column direction, of the subpixels defined by the scan lines that are scanned in each field.

As described above, when the scan line driver circuit 6 scans the scan line, the signal line driver circuit 8 is driven to supply data signals of the same polarity to each pair of subpixels aligned along the row direction and included in the same main pixel, from the data signal line of the first column to the data signal line of the Q-th column.

By the scan line driver circuit 6 and the signal line driver circuit 8 being driven in the manner described above, the polarity of the data signals applied to the (p, q)-th subpixel R and the (p+3, q)-th subpixel W becomes “+” as shown in FIG. 7. The polarity of the data signals applied to the (p+4, q)-th subpixel R, the (p, q+2)-th subpixel R, the (p+7, q)-th subpixel W, and the (p+3, q+2)-th subpixel W becomes “−” as shown in FIG. 7.

Similarly, in the second field of the x-th frame, the polarity of the data signals applied to the (p+1, q)-th subpixel W and the (p+2, q)-th subpixel R becomes “+” as shown in FIG. 7. The polarity of the data signals applied to the (p+5, q)-th subpixel W, the (p+6, q)-th subpixel R, the (p+1, q+2)-th subpixel W, and the (p+2, q+2)-th subpixel R becomes “−” as shown in FIG. 7.

As described above, in the present embodiment, the signal line driver circuit 8 conducts the one-dot reverse driving such that data signals of opposite polarities are applied to respective two subpixels that display the same color and that are closest to each other in the row direction and in the column direction, of subpixels defined by scan lines that are scanned in the first field or the second field of the first frame.

That is, in each field, with respect to the row direction and the column direction, respectively, the signal line driver circuit 8 causes the polarities of data signals applied to respective selected pixels to be reversed every two subpixels adjacent to each other in the row direction, which constitute one main pixel, and every two subpixels adjacent to each other in the column direction (or in other words, every 2×2 selected pixel group).

(x+1-th Frame)

As shown in FIG. 6, the polarities of the data signals to be applied to the respective subpixels in the first field of the x+1-th frame are opposite to the polarities of the data signals that were applied to the corresponding subpixels in the first field of the x-th frame. The polarities of the data signals to be applied to the respective subpixels in the second field of the x+1-th frame are opposite to the polarities of the data signals that were applied to the corresponding subpixels in the second field of the x-th frame.

As described above, the polarity of data signal to be applied to each pixel that is to be selected in one field is made opposite to the polarity of the data signal that was applied to the pixel in an immediately preceding field to that one field, the immediately preceding field being where the pixel to be selected was previously selected.

In the present embodiment, the case in which, when conducting the two-line interlaced driving and the two-dot reverse driving, with respect to the row direction, the signal line driver circuit 8 causes the polarities of data signals applied to respective subpixels to be reversed every two subpixels aligned along the row direction and included in the same main pixel was described as an example, but the present invention is not limited thereto. For example, the signal line driver circuit 8 may be configured such that, with respective to the row direction, data signals having different polarities are applied to two subpixels, respectively, that are aligned along the row direction and that are included in the same main pixel, and the polarities of data signals applied to subpixels are reversed every two subpixels aligned along the row direction and included in different main pixels adjacent to each other.

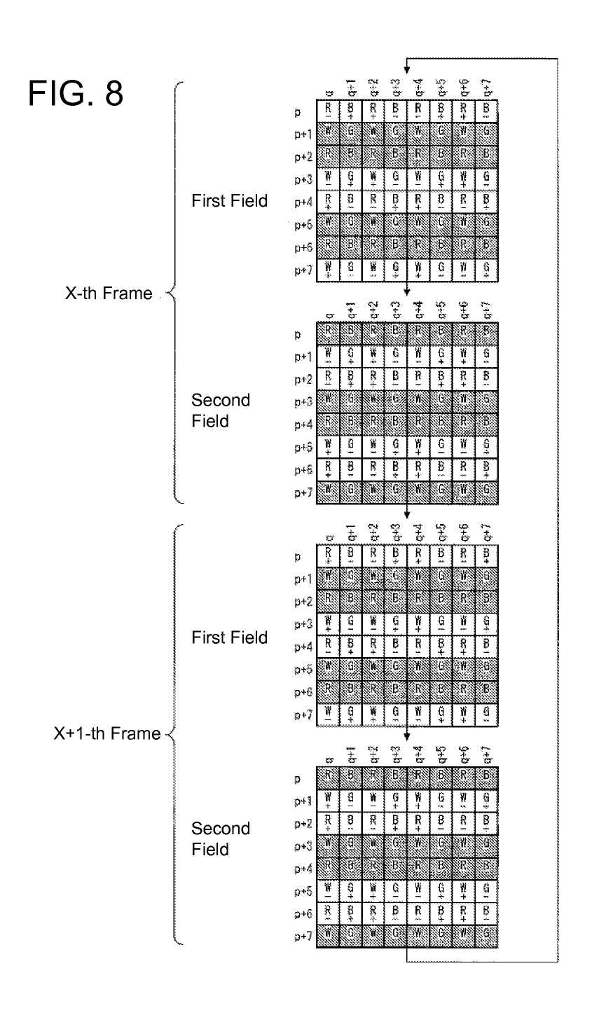

The driving method in which polarities of data signals to be applied to subpixels are reversed every two subpixels that are adjacent to each other along the row direction and that are included in different main pixels, respectively, when conducting the two-dot reverse driving together with the two-line interlaced driving will be explained with reference to FIG. 8. FIG. 8 is a transition diagram schematically showing changes in polarities of respective subpixels in the liquid crystal display device 1 of the present embodiment.

(x-th Frame)

As shown in FIG. 8, in the first field of the x-th frame, the scan line driver circuit 6 scans the scan line of the p-th row, the scan line of the p+3-th row, the scan line of the p+4-th row, and the scan line of the p+7-th row from top to bottom. At this time, the scan line of the p+1-th row, the scan line of the p+2-th row, the scan line of the p+5-th row, and the scan line of the p+6-th row, which are scan lines for the second field, are skipped.

In this manner, the scan line driver circuit 6 scans the scan lines from the first row to the P-th row, skipping two rows at a time, thereby selecting each scan line in every other field.

At this time, the signal line driver circuit 8 applies data signals of the same polarity to two subpixels that are adjacent to each other and that are included in different main pixels, respectively. Also, the polarities of the data signals are reversed every pair of subpixels that are closest to each other in the column direction, of the subpixels defined by the scan lines that are scanned in each field.

As described above, when the scan line driver circuit 6 scans the scan lines, the signal line driver circuit 8 is driven to supply data signals of the same polarity to respective two subpixels aligned along the row direction and included in different main pixels, respectively, from the data signal line of the first column to the data signal line of the Q-th column.

By the scan line driver circuit 6 and the signal line driver circuit 8 being driven in the manner described above, the polarity of the data signals applied to the (p, q)-th subpixel R and the (p+3, q)-th subpixel W becomes “−” as shown in FIG. 8. The polarity of the data signals applied to the (p+4, q)-th subpixel R, the (p, q+2)-th subpixel R, the (p+7, q)-th subpixel W, and the (p+3, q+2)-th subpixel W becomes “+” as shown in FIG. 8.

Similarly, in the second field of the x-th frame, the polarity of the data signals applied to the (p+1, q)-th subpixel W and the (p+2, q)-th subpixel R becomes “−” as shown in FIG. 8. The polarity of the data signals applied to the (p+5, q)-th subpixel W, the (p+6, q)-th subpixel R, the (p+1, q+2)-th subpixel W, and the (p+2, q+2)-th subpixel R becomes “+” as shown in FIG. 8.

As described above, in the present embodiment, the signal line driver circuit 8 supplies data signals of opposite polarities to each other to respective two subpixels that display the same color and that are closest to each other, in the first field or the second field.

That is, in each field, with respect to the row direction and the column direction, the signal line driver circuit 8 causes the polarities of data signals applied to respective selected pixels every two subpixels adjacent to each other in the row direction and included in different main pixels, respectively, and every two subpixels adjacent to each other in the column direction.

(x+1-th Frame)

As shown in FIG. 8, the polarities of the data signals to be applied to the respective subpixels in the first field of the x+1-th frame are opposite to the polarities of the data signals that were applied to the corresponding subpixels in the first field of the x-th frame. The polarities of the data signals to be applied to the respective subpixels in the second field of the x+1-th frame are opposite to the polarities of the data signals that were applied to the corresponding subpixels in the second field of the x-th frame.

As described above, the polarity of data signal to be applied to each pixel that is to be selected in one field is made opposite to the polarity of the data signal that was applied to the pixel in an immediately preceding field to that one field, the immediately preceding field being where the pixel to be selected was previously selected.

In the present embodiment, when conducting the two-line interlaced driving and the two-dot reverse driving, with respect to the column direction, the signal line driver circuit 8 was configured to cause the polarities of data signals applied to respective subpixels to be reversed for each pair of two subpixels that are respectively defined by scan lines (such as scan lines of the p-th row and the p+3-th row in FIG. 7, for example) that have therebetween two adjacent rows of scan lines that are skipped in the first field of each frame, for example. However, the present embodiment is not limited thereto. For example, the signal line driver circuit 8 may be configured such that, with respect to the column direction, the polarities of data signals to be applied to respective subpixels are reversed each pair of two adjacent subpixels that are defined by scan lines disposed between two rows of scan lines that are skipped in the first field of each frame.

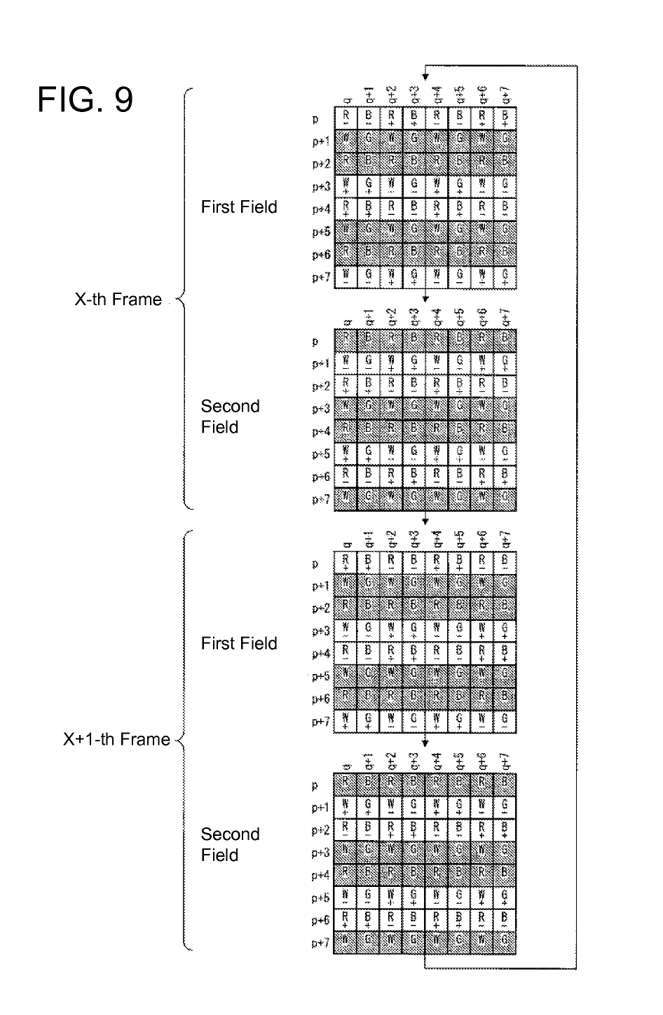

With respect to FIG. 9, a case will be explained in which, when conducting the two-line interlaced driving and the two-dot reverse driving, the polarities of data signals to be applied to respective subpixels are reversed every pair of two adjacent subpixels that are defined by scan lines disposed between two rows of scan lines that are skipped in the first field of each frame. FIG. 9 is a transition diagram schematically showing changes in polarities of respective subpixels when the polarities of data signals to be applied to respective subpixels are reversed every pair of two adjacent subpixels that are defined by scan lines disposed between two rows of scan lines that are skipped in the first field of each frame, in the case in which two-line interlaced driving and two-dot reverse driving are conducted in the liquid crystal display device 1 of the present embodiment.

As shown in FIG. 9, the scan line driver circuit 6 conducts the two-line interlaced driving by scanning the scan line of the p-th row, the scan line of the p+3-th row, the scan line of the p+4-th row, and the scan line of the p+7-th row from top to bottom in the first field of the x-th frame. The scan line of the p+2-th row, the scan line of the p+3-th row, the scan line of the p+5-th row, and the scan line of the p+6-th row, which are scan lines for the second field, are skipped.

In this manner, the scan line driver circuit 6 scans the scan lines from the first row to the P-th row, skipping two rows at a time. That is, the scan line driver circuit 6 conducts scanning on the respective scan lines by alternately scanning and skipping two scan lines, such that each scan line is selected in every other field.

At this time, the signal line driver circuit 8 causes the polarities of data signals to be reversed every two subpixels aligned along the row direction and included the same main pixel in the row direction, and causes the polarities of data signals to be reversed every one of main pixels adjacent to each other in the row direction. Also, the polarities of data signals are reversed every two adjacent subpixels that are defined by scan lines disposed between two rows of scan lines that are skipped in the first field. Furthermore, the signal line driver circuit 8 applies the same subpixel with a data signal that has the opposite polarity to that of the previous frame.

As described above, when the scan line driver circuit 6 scans the scan lines, the signal line driver circuit 8 is driven to supply data signals of the same polarity to each pair of subpixels aligned along the row direction and included in the same main pixel, from the data signal line of the first column to the data signal line of the Q-th column.

Accordingly, as shown in FIG. 9, the polarities of the data signals to be applied to the respective subpixels in the first field of the x+1-th frame are opposite to the polarities of the data signals that were applied to the corresponding subpixels in the first field of the x-th frame. The polarities of the data signals to be applied to the respective subpixels in the second field of the x+1-th frame are opposite to the polarities of the data signals that were applied to the corresponding subpixels in the second field of the x-th frame.

As described above, the polarity of data signal to be applied to each pixel that is to be selected in one field is made opposite to the polarity of the data signal that was applied to the pixel in an immediately preceding field to that one field, the immediately preceding field being where the pixel to be selected was previously selected.

(One-Line Interlaced Driving, m-Dot Reverse Driving)

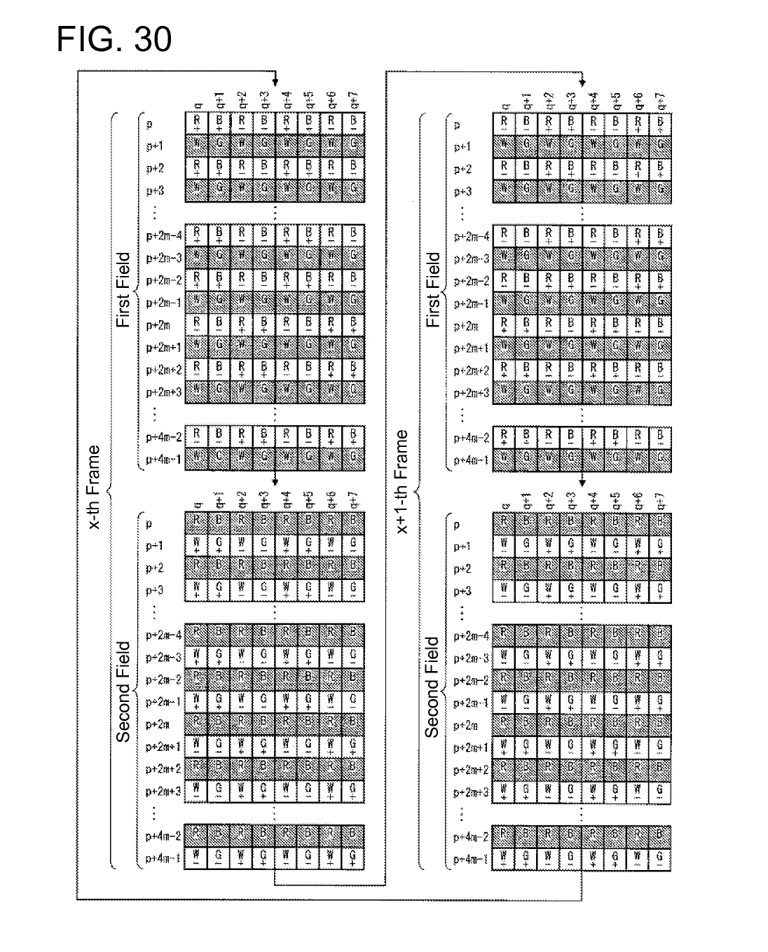

With reference to FIG. 30, an example will be explained in which the one-line interlaced driving (n=1) and the m-dot reverse driving are conducted. FIG. 30 is a transition diagram schematically showing changes in polarities of respective subpixels when conducting one-line interlaced driving and m-dot reverse driving in the liquid crystal display device 1 of the present embodiment. The m-dot reverse driving in the present specification refers to a driving method in which the polarities of data signals are reversed every “m rows×two columns” of selected pixels, out of selected pixels on selected scan lines in each field, for example. However, the present embodiment is not limited thereto, and this is one example of driving methods in which the polarities of data signals are reversed every “m rows×a certain number of columns” of selected pixels.

Because the one-line interlaced driving is conducted, in the first field and the second field of each frame, every second scan line is scanned as shown in FIG. 30.

(x-th Frame)

As shown in FIG. 30, the scan line driver circuit 6 scans respective scan lines of the p-th row, the p+2-th row, . . . , the p+2m−2-th row, p+2m-th row, . . . , and p+4m−2-th row from top to bottom in the first field of the x-th frame. In this manner, the scan line driver circuit 6 scans every second scan line from the scan line of the first row to the scan line of the P-th row, selecting each scan line in every other field.

The signal line driver circuit 8 applies data signals of the same polarity to each pair of subpixels aligned along the row direction and included in the same main pixel. Also, the polarities of data signals are reversed every two subpixels that are closest to each other in the column direction, of the subpixels defined by the scan lines that are scanned in each field.

By the scan line driver circuit 6 and the signal line driver circuit 8 being driven in the manner described above, the polarity of the data signals applied to the (p, q)-th, the (p+2, q)-th, . . . , and the (p+2m−2, q)-th subpixels R becomes “+” as shown in FIG. 30. The polarity of the data signals applied to the (p+2m, q)-th, . . . , the (p+4m−2, q)-th, the (p, q+2)-th, . . . , and the (p+2m−2, q+2)-th subpixels R becomes “−” as shown in FIG. 30.

Similarly, in the second field of the x-th frame, the polarity of the data signals applied to the (p+2 m+1, q)-th, . . . , the (p+4m−1, q)-th subpixels W becomes “+” polarity as shown in FIG. 30. The polarity of the data signals applied to the (p+1, q)-th, . . . , the (p+2m−1, q)-th, the (p+1, q+2)-th, . . . , the (p+2m−1, q+2)-th subpixels W becomes “−.”

(x+1-th Frame)

As shown in FIG. 30, the polarities of the data signals to be applied to the respective subpixels in the first field of the x+1-th frame are opposite to the polarities of the data signals that were applied to the corresponding subpixels in the first field of the x-th frame. The polarities of the data signals to be applied to the respective subpixels in the second field of the x+1-th frame are opposite to the polarities of the data signals that were applied to the corresponding subpixels in the second field of the x-th frame.

As described above, the polarity of data signal to be applied to each pixel that is to be selected in one field is made opposite to the polarity of the data signal that was applied to the pixel in an immediately preceding field to that one field, the immediately preceding field being where the pixel to be selected was previously selected.

With the above-mentioned configuration, the signal line driver circuit 8 applies data signals such that, out of the subpixels defined by the scan lines that are scanned in each field, the polarities of the data signals are reversed every group of “m” subpixels that display the same color and that are closest to each other in the column direction, and every pair of subpixels that are closest to each other in the row direction. In other words, the signal line driver circuit 8 applies data signals such that, of the subpixels constituting the respective picture elements, the polarities of data signals are reversed every “m” subpixels that display the same color and that are closest to each other in the column direction, and every pair of subpixels that are closest to each other in the row direction.

### Embodiment 2

In Embodiment 1, the example in which four subpixels constituting each main pixel have two pixels aligned respectively in the column direction and in the row direction was described, but the present invention is not limited thereto. For example, a configuration in which four subpixels constituting each main pixel are aligned in a row along the row direction may be employed.

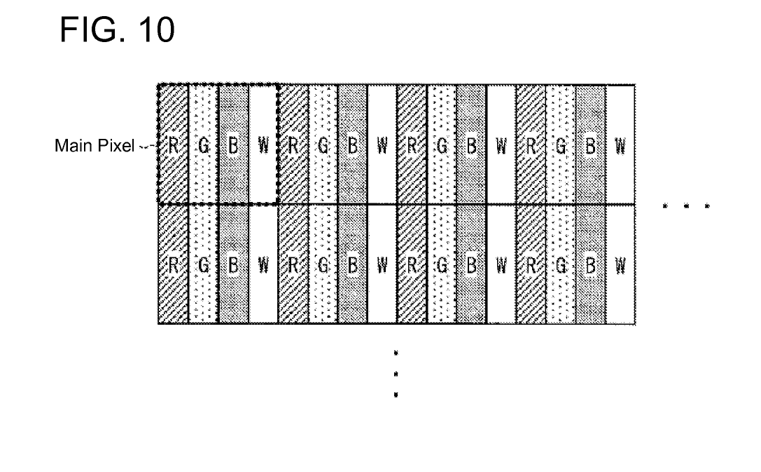

A liquid crystal display device of another embodiment of the present invention will be explained with reference to FIGS. 10 to 15.

(Configuration of Pixels)

With reference to FIG. 10, the arrangement of four subpixels constituting each main pixel of the display panel 2 in the liquid crystal display device 1 of the present embodiment will be explained. FIG. 10 shows the arrangement of four subpixels constituting each main pixel of the display panel 2 in the liquid crystal display device 1 of the present embodiment.

As shown in FIG. 10, one main pixel is constituted of four subpixels of a subpixel R, a subpixel B, a subpixel G, and a subpixel W. The four subpixels are aligned in a row along the row direction, and as shown in FIG. 10, for example, the four subpixels are aligned adjacent to each other along the row direction in order of the subpixel R, the subpixel G, the subpixel B, and the subpixel W.

In the present embodiment, an example will be explained in which the subpixel R, the subpixel G, the subpixel B, and the subpixel W are arranged in this order adjacent to each other along the row direction, but the present invention is not limited thereto. The four subpixels can be arranged in 24 different ways, which is the factorial of four, and for example, the four subpixels may be arranged such that the subpixel R, the subpixel B, the subpixel G, and the subpixel W are adjacent to each other in this order along the row direction.

In the present embodiment, an example will be explained in which one main pixel is constituted of four subpixels of the subpixel R, the subpixel B, the subpixel G, and the subpixel W, but the present invention is not limited thereto. For example, a subpixel Y may be used instead of the subpixel W, or a subpixel of another color may also be used.

(One-Line Interlaced Driving, One-Dot Reverse Driving)

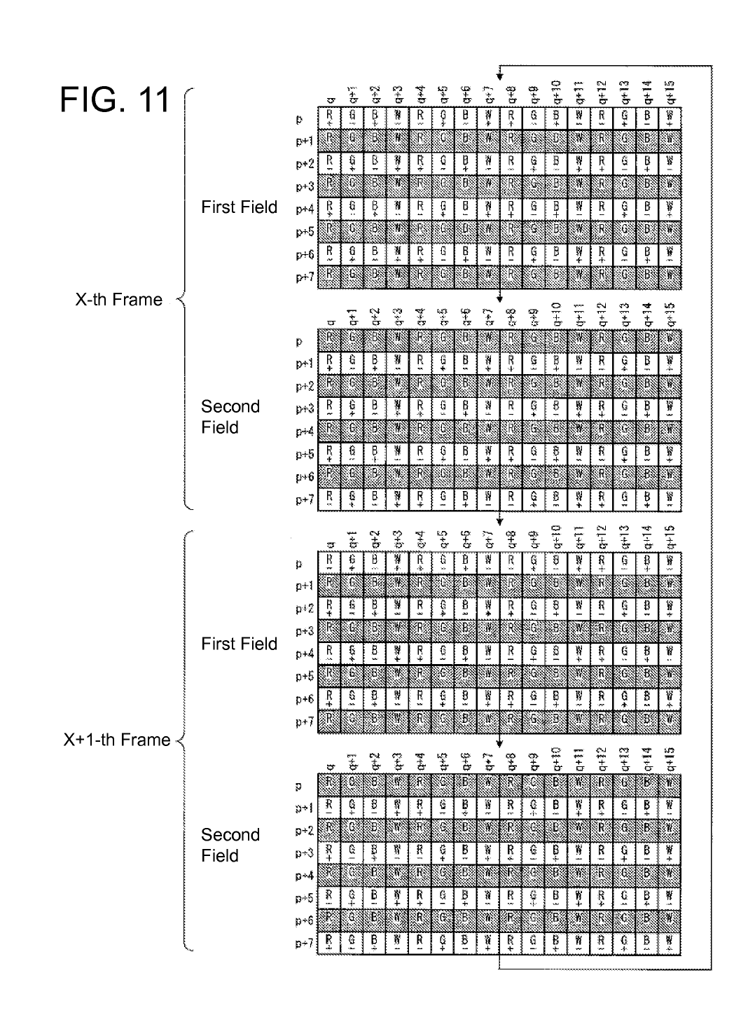

First, the case in which the one-line interlaced driving (n=1) and the one-dot reverse driving (m=1) are conducted will be explained with reference to FIG. 11. FIG. 11 is a transition diagram schematically showing changes in polarities of respective subpixels in the liquid crystal display device 1 of the present embodiment.

Because the one-line interlaced driving is conducted, in the first field, the scan line of the p-th row, the scan line of the p+2-th row, the scan line of the p+4-th row, and the scan line of the p+6-th row are scanned as shown in FIG. 11. In the second field, the scan line of the p+1-th row, the scan line of the p+3-th row, the scan line of the p+5-th row, and the scan line of the p+7-th row are scanned. That is, the first field and the second field are constituted by scanning every other scan line.

(x-th Frame)

As shown in FIG. 11, in the first field of the x-th frame, the scan line driver circuit 6 selects the scan line of the p-th row, the scan line of the p+2-th row, the scan line of the p+4-th row, and the scan line of the p+6-th row from top to bottom. At this time, the scan line of the p+1-th row, the scan line of the p+3-th row, the scan line of the p+5-th row, and the scan line of the p+7-th row, which are scan lines for the second field, are skipped. Accordingly, the scan line driver circuit 6 scans every other scan line from the scan line of the first row to the scan line of the P-th row.

As shown in FIG. 11, in the first field of the x-th frame, when the scan line driver circuit 6 scans the scan line of the p-th row, the signal line driver circuit 8 supplies data signals having the “+” polarity to the data signal lines of the q-th column and the q+2-th row, and supplies data signals having the “−” polarity to the data signal lines of the q+1-th column and the q+3-th row. The signal line driver circuit 8 also supplies data signals having the “−” polarity to the data signal lines of the q+4-th column and the q+6-th column, and supplies data signals having the “+” polarity to the data signal lines of the q+5-th column and the q+7-th. Furthermore, the signal line driver circuit 8 also supplies data signals having the “+” polarity to the data signal lines of the q+8-th column, the q+10-th column, the q+13-th column, and the q+15-th column, and supplies data signals having the “−” polarity to the data signal lines of the q+9-th column, the q+11-th column, the q+12-th column, and the q+14-th column.

In the first field of the x-th frame, when the scan line driver circuit 6 scans the scan line of the p+2-th row, the signal line driver circuit 8 supplies data signals having the “−” polarity to the data signal lines of the q-th column and the q+2-th row, and supplies data signals having the “+” polarity to the data signal lines of the q+1-th column and the q+3-th row. The signal line driver circuit 8 also supplies data signals having the “+” polarity to the data signal lines of the q+4-th column and the q+6-th column, and supplies data signals having the “−” polarity to the data signal lines of the q+5-th column and the q+7-th. Furthermore, the signal line driver circuit 8 also supplies data signals having the “−” polarity to the data signal lines of the q+8-th column, the q+10-th column, the q+13-th column, and the q+15-th column, and supplies data signals having the “+” polarity to the data signal lines of the q+9-th column, the q+11-th column, the q+12-th column, and the q+14-th column.

As described above, in the present embodiment, when the scan line driver circuit 6 scans the scan line of the p+2-th row, the signal line driver circuit 8 applies data signals to four subpixels aligned adjacent to each other along the row direction and included in the same main pixel such that the polarities of the data signals are reversed every subpixel. Furthermore, the signal line driver circuit 8 reverses the polarities of data signals every one of main pixels that are adjacent to each other along the row direction.

By the scan line driver circuit 6 and the signal line driver circuit 8 being driven in the manner described above, the polarity of the data signals applied to the (p, q)-th subpixel R and the (p, q+2)-th subpixel B becomes “+” as shown in FIG. 11. The polarity of the data signal applied to the (p+2, q)-th subpixel R, the (p, q+4)-th subpixel R, the (p+2, q+2)-th subpixel B, and the (p, q+6)-th subpixel B becomes “−” as shown in FIG. 11.

The polarity of the data signals applied to the (p, q+1)-th subpixel G and the (p, q+3)-th subpixel W becomes “−” as shown in FIG. 11. The polarity of the data signals applied to the (p+2, q+1)-th subpixel G, the (p, q+5)-th subpixel G, the (p+2, q+3)-th subpixel W, and the (p, q+7)-th subpixel W becomes “+” as shown in FIG. 11.

Similarly, in the second field of the x-th frame, the polarity of data signals applied to the (p+1, q)-th subpixel R, and the (p+1, q+2)-th subpixel B becomes “+” as shown in FIG. 11. The polarity of the data signals applied to the (p+3, q)-th subpixel R, the (p+1, q+4)-th subpixel R, the (p+3, q+2)-th subpixel B, and the (p+1, q+6)-th subpixel B becomes “−” as shown in FIG. 11.

The polarity of the data signals applied to the (p+1, q+1)-th subpixel G and the (p+1, q+3)-th subpixel W becomes “−” as shown in FIG. 11. The polarity of the data signals applied to the (p+3, q+1)-th subpixel G, the (p+1, q+5)-th subpixel G, the (p+3, q+3)-th subpixel W, and the (p+1, q+7)-th subpixel W becomes “+” as shown in FIG. 11.

Accordingly, the signal line driver circuit 8 is driven such that respective subpixels that display the same color and that are closest to each other are applied with data signals having the opposite polarities, out of subpixels that are defined by scan lines selected in the first field.

(x+1-th Frame)

As shown in FIG. 11, the polarities of the data signals to be applied to the respective subpixels in the first field of the x+1-th frame are opposite to the polarities of the data signals that were applied to the corresponding subpixels in the first field of the x-th frame. The polarities of the data signals to be applied to the respective subpixels in the second field of the x+1-th frame are opposite to the polarities of the data signals that were applied to the corresponding subpixels in the second field of the x-th frame.

As described above, the polarity of data signal to be applied to each pixel that is to be selected in one field is made opposite to the polarity of the data signal that was applied to the pixel in an immediately preceding field to that one field, the immediately preceding field being where the pixel to be selected was previously selected.

In the manner described above, the scan line driver circuit 6 conducts the one-line interlaced driving in which the respective scan lines are alternatively scanned, thereby selecting each scan line in every other field.

The signal line driver circuit 8 also conducts the one-dot reverse driving in which respective four subpixels disposed adjacent to each other in the row direction and included in the same main pixel are applied with data signals such that the polarities thereof are reversed every subpixel, and the polarities of data signals are reversed every one of the main pixels adjacent to each other along the row direction.

In other words, in each field, the signal line driver circuit 8 causes the polarities of data signals applied to respective selected pixels to be reversed every group of four subpixels included in the same main pixel in the row direction, and one subpixel in the column direction, respectively, (or in other words, every 4×1 selected pixel group), with respect to the row direction and the column direction, respectively.

The signal line driver circuit 8 may be configured such that respective two subpixels displaying the same color and aligned along the row direction are not applied with the data signal of the same polarity by reversing the polarities of data signals every one of subpixels that constitute each main pixel, and by applying data signals of opposite polarities to the same subpixels in respective main pixels adjacent to each other.

(One-Line Interlaced Driving, Two-Dot Reverse Driving)

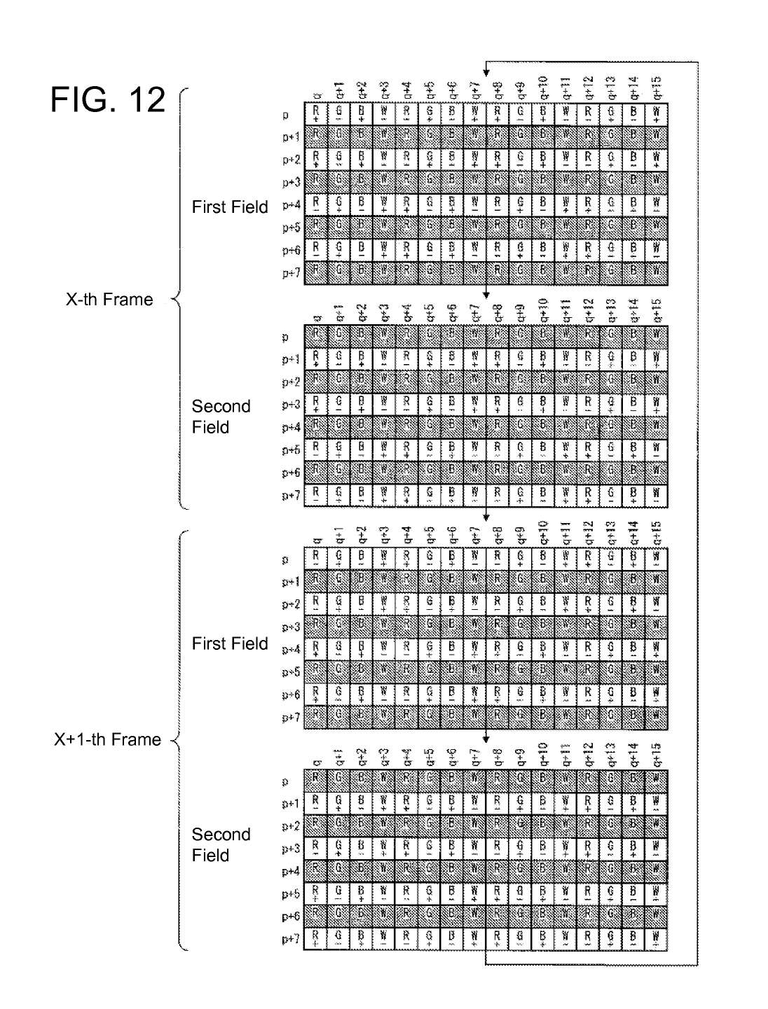

Next, the case in which the one-line interlaced driving (n=1) and the two-dot reverse driving (m=2) are conducted in the present embodiment will be explained with reference to FIG. 12. FIG. 12 is a transition diagram schematically showing changes in polarities of respective subpixels when conducting one-line interlaced driving and two-dot reverse driving in the liquid crystal display device 1 of the present embodiment.

(x-th Frame)

As shown in FIG. 12, in the first field of the x-th frame, the scan line driver circuit 6 selects the scan line of the p-th row, the scan line of the p+2-th row, the scan line of the p+4-th row, and the scan line of the p+6-th row from top to bottom. The scan line driver circuit 6 skips the scan line of the p+1-th row, the scan line of the p+3-th row, the scan line of the p+5-th row, and the scan line of the p+7-th row, which are scan lines for the second field.

In this manner, the scan line driver circuit 6 scans every second scan line from the scan line of the first row to the scan line of the P-th row, selecting each scan line in every other field.

At this time, as shown in FIG. 12, during a period in which the scan line driver circuit 6 is scanning the scan lines, the signal line driver circuit 8 applies data signals to four subpixels aligned adjacent to each other in the row direction and constituting the same main pixel, such that the polarities of the data signals are reversed every subpixel. Furthermore, the signal line driver circuit 8 reverses the polarities of data signals every one of main pixels that are adjacent to each other along the row direction.

Accordingly, in the first field of the x-th frame, the polarity of the data signals applied to the (p, q)-th and the (p+2, q)-th subpixels R and the (p, q+2)-th and the (p+2, q+2)-th subpixels B becomes “+” as shown in FIG. 12. The polarity of the data signals applied to the (p+4, q)-th, the (p+6, q)-th, the (p, q+4)-th, and the (p+2, q+4) subpixels R and the (p+4, q+2)-th, the (p+6, q+2)-th, the (p, q+6)-th, and the (p+2, q+6)-th subpixels B becomes “−” as shown in FIG. 12.

The polarity of the data signals applied to the (p, q+1)-th and the (p+2, q+1)-th subpixels G, and the (p, q+3)-th and the (p+2, q+3)-th subpixels W becomes “−” as shown in FIG. 12. The polarity of the data signals applied to the (p+4, q+1)-th, the (p+6, q+1)-th, the (p, q+5)-th, and the (p+2, q+5)-th subpixels G, and the (p+4, q+3)-th, the (p+6, q+3)-th, and the (p, q+7)-th subpixels B, and the (p+2, q+7)-th subpixel W becomes “+” as shown in FIG. 12.

Similarly, in the second field of the x-th frame, the polarity of the data signals applied to the (p+1, q)-th and the (p+3, q)-th subpixels R and the (p+1, q+2)-th and the (p+3, q+2)-th subpixels B becomes “+” as shown in FIG. 12. The polarity of the data signals applied to the (p+5, q)-th, the (p+7, q)-th, the (p+1, q+4)-th, and the (p+3, q+4)-th subpixels R and the (p+5, q+2)-th, the (p+7, q+2)-th, the (p+1, q+6)-th, and the (p+3, q+6)-th subpixels B becomes “−” as shown in FIG. 12.

The polarity of the data signals applied to the (p+1, q+1)-th and the (p+3, q+1)-th subpixels G, and the (p+1, q+3)-th and the (p+3, q+3)-th subpixels W becomes “−” as shown in FIG. 12. The polarity of the data signals applied to the (p+5, q+1)-th, the (p+7, q+1)-th, the (p+1, q+5)-th, and the (p+3, q+5)-th subpixels G, and the (p+5, q+3)-th, the (p+7, q+3)-th, and the (p+1, q+7)-th subpixels B, and the (p+3, q+7)-th subpixel W becomes “+” as shown in FIG. 12.

In other words, in each field, the signal line driver circuit 8 causes the polarities of data signals applied to respective selected pixels to be reversed every group of four subpixels constituting the same main pixel in the row direction, and two subpixel in the column direction, respectively (or in other words, every 4×2 selected pixel group), with respect to the row direction and the column direction, respectively.

(x+1-th Frame)

As shown in FIG. 12, the polarities of the data signals to be applied to the respective subpixels in the first field of the x+1-th frame are opposite to the polarities of the data signals that were applied to the corresponding subpixels in the first field of the x-th frame. The polarities of the data signals to be applied to the respective subpixels in the second field of the x+1-th frame are opposite to the polarities of the data signals that were applied to the corresponding subpixels in the second field of the x-th frame.

As described above, the polarity of data signal to be applied to each pixel that is to be selected in one field is made opposite to the polarity of the data signal that was applied to the pixel in an immediately preceding field to that one field, the immediately preceding field being where the pixel to be selected was previously selected.

In the manner described above, the scan line driver circuit 6 repeatedly conducts scanning on every second scan line of the respective scan lines such that each scan line is selected in every other field. The signal line driver circuit 8 applies data signals to four subpixels aligned adjacent to each other along the row direction and constituting each main pixel such that the polarities thereof are reversed every subpixel, and also causes the polarities of data signals to be reversed every one of the main pixels adjacent to each other along the row direction. The signal line driver circuit 8 also causes the polarities of applied data signals to be reversed every pair of two adjacent subpixels in the column direction.

The signal line driver circuit 8 causes the polarities of data signals to be reversed every one of subpixels constituting each main pixel, and causes the polarities of data signals to be reversed every main pixel, thereby preventing respective subpixels of the same color adjacent along the row direction from being applied with a data signal of the same polarity.

(Two-line Interlaced Driving, One-dot Reverse Driving)

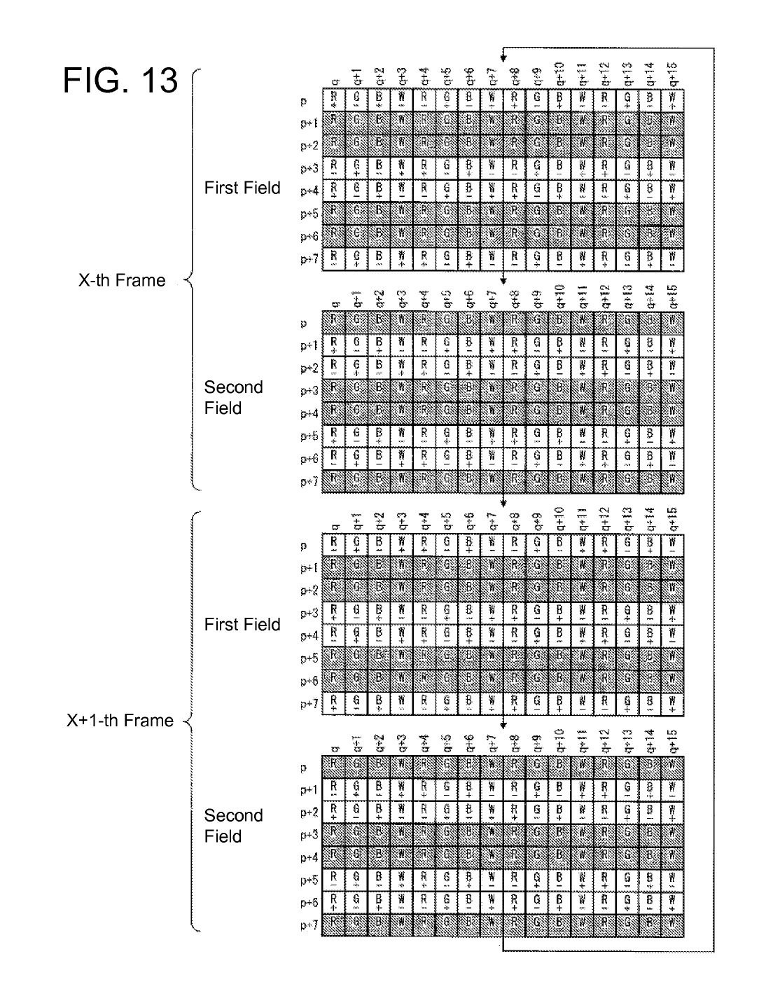

Next, the case in which the two-line interlaced driving (n=2) and the one-dot reverse driving (m=2) are conducted in the present embodiment will be explained with reference to FIG. 13. FIG. 13 is a transition diagram schematically showing changes in polarities of respective subpixels when conducting two-line interlaced driving and one-dot reverse driving in the liquid crystal display device 1 of the present embodiment.

(x-th Frame)

As shown in FIG. 13, the scan line driver circuit 6 conducts the two-line interlaced driving by scanning the scan line of the p-th row, the scan line of the p+3-th row, the scan line of the p+4-th row, and the scan line of the p+7-th row from top to bottom in the first field of the x-th frame. The scan line of the p+2-th row, the scan line of the p+3-th row, the scan line of the p+5-th row, and the scan line of the p+6-th row, which are scan lines for the second field, are skipped.

In this manner, the scan line driver circuit 6 scans the respective scan lines from the first row to the P-th row, skipping two rows at a time, thereby selecting each scan line in every other field.

At this time, as shown in FIG. 13, when the scan line driver circuit 6 is scanning the scan lines, the signal line driver circuit 8 applies data signals to four subpixels aligned adjacent to each other in the row direction and constituting the same main pixel, such that the polarities of the data signals are reversed every subpixel. Furthermore, the signal line driver circuit 8 reverses the polarities of data signals every one of main pixels that are adjacent to each other along the row direction.

By the scan line driver circuit 6 and the signal line driver circuit 8 being driven in the manner described above, in the first field of the x-th frame, the polarity of the data signals applied to the (p, q)-th subpixel R and the (p, q+2)-th subpixel B becomes “+” as shown in FIG. 13. The polarity of the data signals applied to the (p+3, q)-th subpixel R, the (p, q+4)-th subpixel R, the (p+3, q+2)-th subpixel B, and the (p, q+6)-th subpixel B becomes “−” as shown in FIG. 13.

The polarity of the data signals applied to the (p, q+1)-th subpixel G and the (p, q+3)-th subpixel W becomes “−” as shown in FIG. 13. The polarity of the data signals applied to the (p+3, q+1)-th subpixel G, the (p, q+5)-th subpixel G, the (p+3, q+3)-th subpixel W, and the (p, q+7)-th subpixel W becomes “+” as shown in FIG. 113.

Similarly, in the second field of the x-th frame, the polarity of data signals applied to the (p+1, q)-th subpixel R and the (p+1, q+2)-th subpixel B becomes “+” as shown in FIG. 13. The polarity of the data signals applied to the (p+2, q)-th subpixel R, the (p+1, q+4)-th subpixel R, the (p+2, q+2)-th subpixel B, and the (p+1, q+6)-th subpixel B becomes “−” as shown in FIG. 13.

The polarity of the data signals applied to the (p+1, q+1)-th subpixel G and the (p+1, q+3)-th subpixel W becomes “−” as shown in FIG. 13. The polarity of the data signals applied to the (p+2, q+1)-th subpixel G, the (p+1, q+5)-th subpixel G, the (p+2, q+3)-th subpixel W, and the (p+1, q+7)-th subpixel W becomes “+” as shown in FIG. 13.

In other words, in each field, the signal line driver circuit 8 causes the polarities of data signals applied to respective selected pixels to be reversed every group of four subpixels constituting the same main pixel in the row direction, and one subpixel in the column direction, respectively (or in other words, every 4×1 selected pixel group), with respect to the row direction and the column direction.

(x+1-th Frame)

As shown in FIG. 13, the polarities of the data signals to be applied to the respective subpixels in the first field of the x+1-th frame are opposite to the polarities of the data signals that were applied to the corresponding subpixels in the first field of the x-th frame. The polarities of the data signals to be applied to the respective subpixels in the second field of the x+1-th frame are opposite to the polarities of the data signals that were applied to the corresponding subpixels in the second field of the x-th frame.

As described above, the polarity of data signal to be applied to each pixel that is to be selected in one field is made opposite to the polarity of the data signal that was applied to the pixel in an immediately preceding field to that one field, the immediately preceding field being where the pixel to be selected was previously selected.

In the manner described above, the scan line driver circuit 6 repeatedly conducts scanning on the respective scan lines while skipping two rows at a time, and selects each scan line in every other field.

The signal line driver circuit 8 applies data signals to four subpixels aligned adjacent to each other along the row direction and constituting each main pixel such that the polarities thereof are reversed every subpixel, and also causes the polarities of data signals to be reversed every one of main pixels adjacent to each other along the row direction. The signal line driver circuit 8 also causes the polarities of applied data signals to be reversed every one of subpixels adjacent to each other in the column direction. Furthermore, the signal line driver circuit 8 applies the same subpixel with a data signal that has the opposite polarity to that of the previous frame.

(Two-Line Interlaced Driving, Two-Dot Reverse Driving)

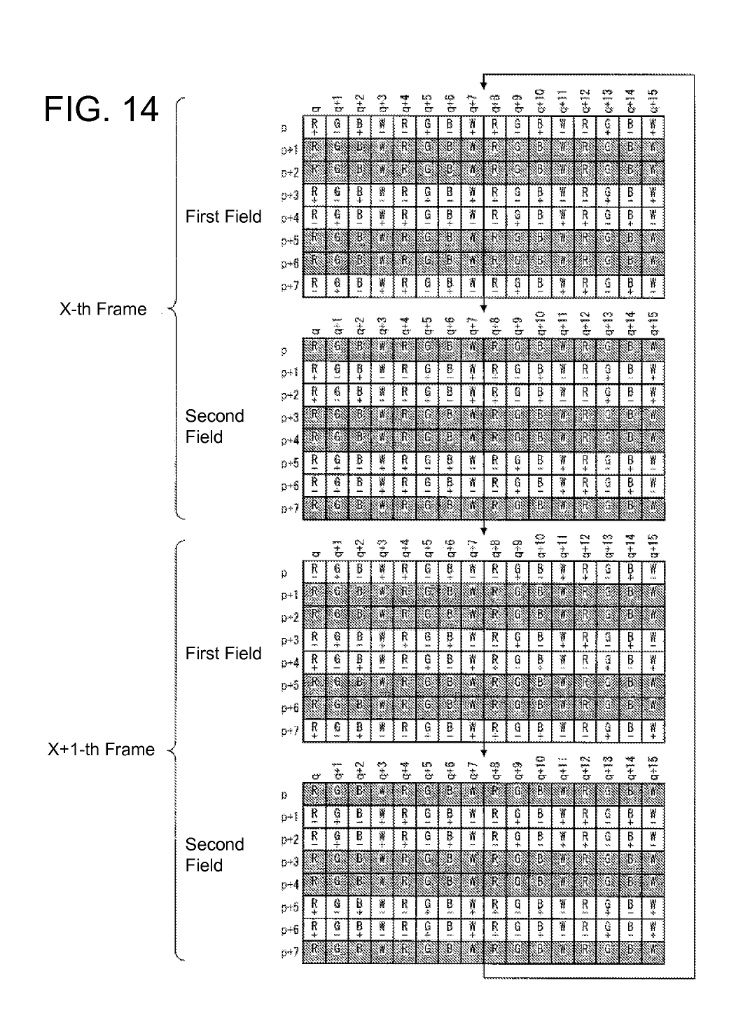

Next, the case in which the two-line interlaced driving (n=2) and the two-dot reverse driving (m=2) are conducted in the present embodiment will be explained with reference to FIG. 14. FIG. 14 is a transition diagram schematically showing changes in polarities of respective subpixels when conducting two-line interlaced driving and one-dot reverse driving in the liquid crystal display device 1 of the present embodiment.

As shown in FIG. 14, the scan line driver circuit 6 conducts the two-line interlaced driving by scanning the scan line of the p-th row, the scan line of the p+3-th row, the scan line of the p+4-th row, and the scan line of the p+7-th row from top to bottom in the first field of the x-th frame. The scan line of the p+2-th row, the scan line of the p+3-th row, the scan line of the p+5-th row, and the scan line of the p+6-th row, which are scan lines for the second field, are skipped. Accordingly, the scan line driver circuit 6 scans the respective scan lines from the first row to the P-th row, skipping two scan lines at a time.

At this time, as shown in FIG. 14, when the scan line driver circuit 6 is scanning the scan lines, the signal line driver circuit 8 applies data signals to four subpixels aligned adjacent to each other in the row direction and constituting the same main pixel, such that the polarities of the data signals are reversed every subpixel, and also reverses the polarities of data signals every one of the main pixels adjacent to each other along the row direction.

In other words, in each field, the signal line driver circuit 8 causes the polarities of data signals applied to respective selected pixels to be reversed every group of four subpixels constituting the same main pixel in the row direction, and two subpixel in the column direction, respectively (or in other words, every 4×2 selected pixel group), with respect to the row direction and the column direction.

The signal line driver circuit 8 applies data signals to four subpixels adjacent to each other along the column direction and constituting each main pixel such that the polarities thereof are reversed every subpixel, and also reverses the polarities of data signals every one of main pixels adjacent to each other along the row direction. The signal line driver circuit 8 also reverses the polarities of data signals every pair of two subpixels adjacent to each other along the column direction. Furthermore, the signal line driver circuit 8 applies the same subpixel with a data signal that has the opposite polarity to that of the previous frame.

In the present embodiment, when conducting the two-line interlaced driving and the two-dot reverse driving, with respect to the column direction, the signal line driver circuit 8 was configured to cause the polarities of data signals applied to respective subpixels to be reversed every pair of two subpixels that are respectively defined by scan lines (such as scan lines of the p-th row and the p+3-th row in FIG. 14, for example) that have therebetween two adjacent rows of scan lines that are skipped in the first field of each frame. However, the present embodiment is not limited thereto. For example, the signal line driver circuit 8 may be configured such that, with respect to the column direction, the polarities of data signals to be applied to respective subpixels are reversed every pair of two adjacent subpixels that are defined by scan lines disposed between two rows of scan lines that are skipped in the first field of each frame.

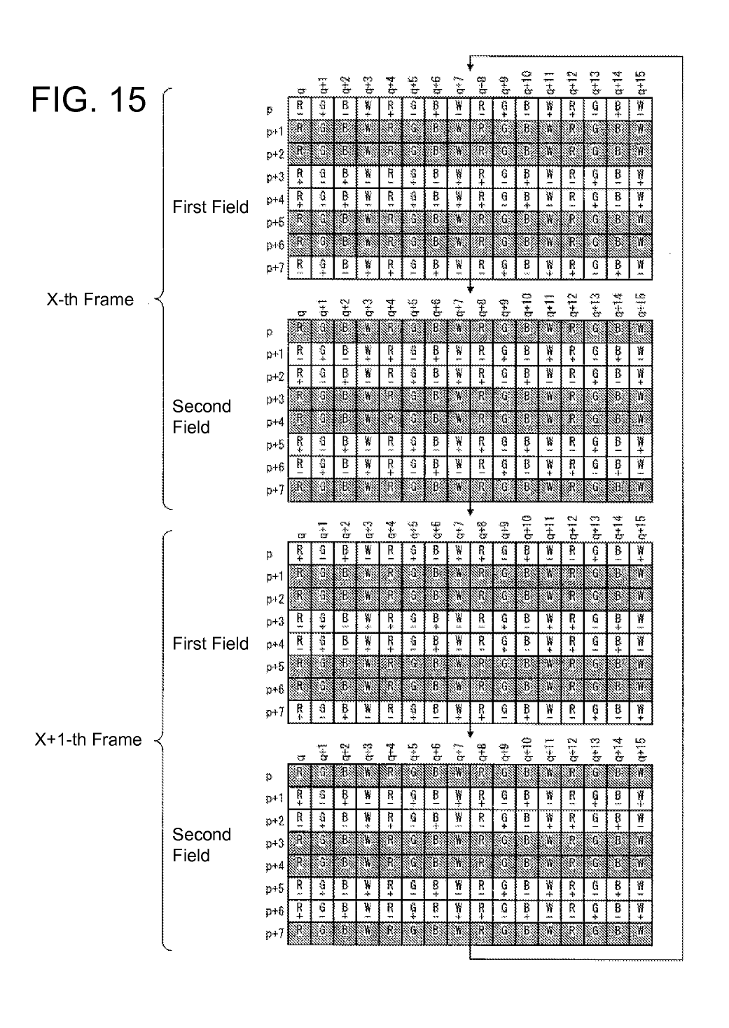

With reference to FIG. 15, an example will be explained in which, when conducting the two-line interlaced driving and the two-dot reverse driving, the polarities of data signals to be applied to respective subpixels are reversed every pair of two adjacent subpixels that are defined by scan lines disposed between two rows of scan lines that are skipped in the first field of each frame. FIG. 15 is a transition diagram schematically showing changes in polarities of respective subpixels when the polarities of data signals to be applied to respective subpixels are reversed every pair of two adjacent subpixels that are defined by scan lines disposed between two rows of scan lines that are skipped in the first field of each frame, in the case in which two-line interlaced driving and two-dot reverse driving are conducted in the liquid crystal display device 1 of the present embodiment.

As shown in FIG. 15, the scan line driver circuit 6 conducts the two-line interlaced driving by scanning the scan line of the p-th row, the scan line of the p+3-th row, the scan line of the p+4-th row, and the scan line of the p+7-th row from top to bottom in the first field of the x-th frame. The scan line of the p+2-th row, the scan line of the p+3-th row, the scan line of the p+5-th row, and the scan line of the p+6-th row, which are scan lines for the second field, are skipped.

In this manner, the scan line driver circuit 6 scans the respective scan lines from the first row to the P-th row, skipping two rows at a time. That is, the scan line driver circuit 6 repeatedly conducts scanning on the respective scan lines, alternately selecting each pair of scan lines, such that each scan line is selected in every other field.

The signal line driver circuit 8 applies data signals to four subpixels adjacent to each other along the row direction and constituting each main pixel such that the polarities thereof are reversed every subpixel, and also reverses the polarities of data signals every one of main pixels adjacent to each other along the row direction. Also, the signal line driver circuit 8 reverses the polarities of data signals every two adjacent subpixels defined by two scan lines that are adjacent to each other in the column direction and that are disposed between two rows of scan lines that are skipped and not scanned. Furthermore, the signal line driver circuit 8 applies the same subpixel with a data signal that has the opposite polarity to that of the previous frame.

Accordingly, as shown in FIG. 15, the polarities of the data signals to be applied to the respective subpixels in the first field of the x+1-th frame are opposite to the polarities of the data signals that were applied to the corresponding subpixels in the first field of the x-th frame. The polarities of the data signals to be applied to the respective subpixels in the second field of the x+1-th frame are opposite to the polarities of the data signals that were applied to the corresponding subpixels in the second field of the x-th frame.

As described above, the polarity of data signal to be applied to each pixel that is to be selected in one field is made opposite to the polarity of the data signal that was applied to the pixel in an immediately preceding field to that one field, the immediately preceding field being where the pixel to be selected was previously selected.

### Embodiment 3

In Embodiment 1, the example in which four subpixels constituting each main pixel have two pixels aligned respectively in the column direction and in the row direction was described, but the present invention is not limited thereto. For example, a main pixel may be constituted of three subpixels, and a configuration in which three subpixels constituting each main pixel are aligned in a row along the row direction may be employed.

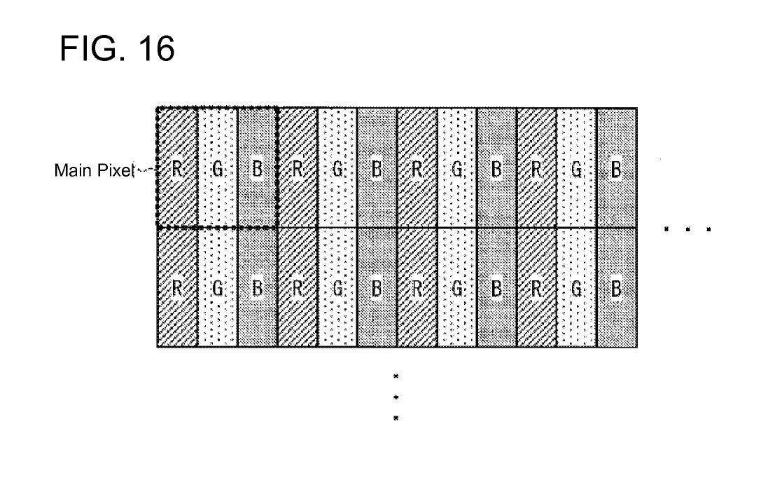

A liquid crystal display device of yet another embodiment of the present invention will be explained with reference to FIGS. 16 to 21.

(Configuration of Pixels)

With reference to FIG. 16, the arrangement of three subpixels constituting each main pixel of the display panel 2 in the liquid crystal display device 1 of the present embodiment will be explained. FIG. 16 shows the arrangement of three subpixels constituting each main pixel of the display panel 2 in the liquid crystal display device 1 of the present embodiment.

As shown in FIG. 16, one main pixel is constituted of three subpixels of a subpixel R, a subpixel G, and a subpixel B. The three subpixels are aligned in a row along the row direction, and as shown in FIG. 16, for example, the subpixel R, the subpixel G, and the subpixel B are arranged adjacent to each other in this order along the row direction.

In the present embodiment, an example will be explained in which the subpixel R, the subpixel G, and the subpixel B are arranged adjacent to each other along the row direction in this order, but the present invention is not limited thereto. The three subpixels can be arranged in six different ways, which is the factorial of three, and for example, the three subpixels may be arranged such that the subpixel R, the subpixel B, and the subpixel G are adjacent to each other in this order along the row direction.

(One-line Interlaced Driving, One-dot Reverse Driving)

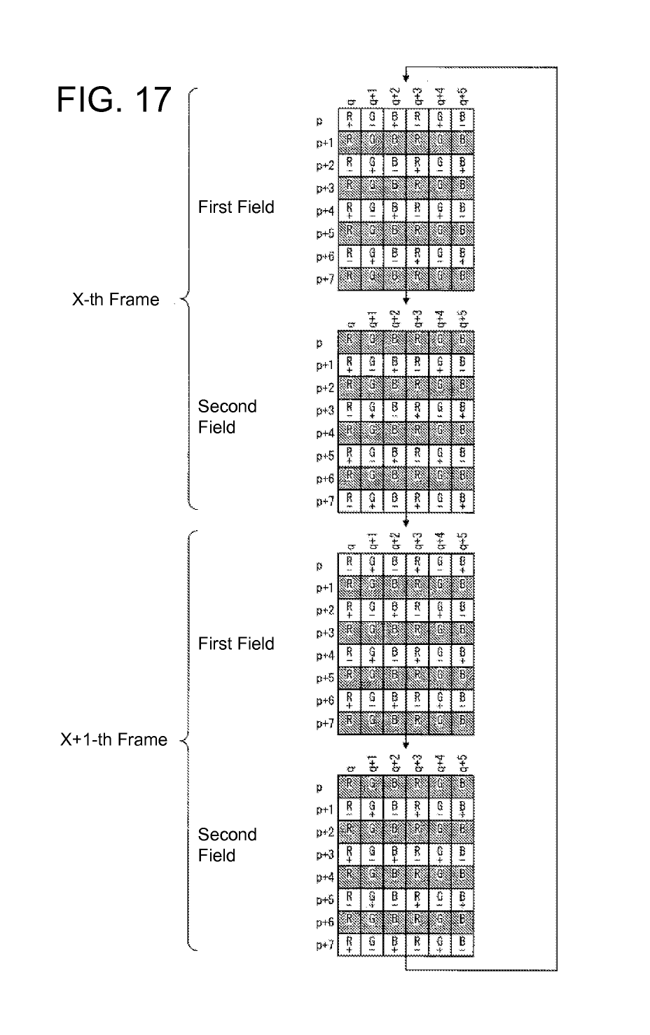

First, the case in which the one-line interlaced driving (n=1) and the one-dot reverse driving (m=1) are conducted will be explained with reference to FIG. 17. FIG. 17 is a transition diagram schematically showing changes in polarities of respective subpixels when conducting one-line interlaced driving and one-dot reverse driving in the liquid crystal display device 1 of the present embodiment.

Because the one-line interlaced driving is conducted, in the first field, the scan line of the p-th row, the scan line of the p+2-th row, the scan line of the p+4-th row, and the scan line of the p+6-th row are scanned as shown in FIG. 17. In the second field, the scan line of the p+1-th row, the scan line of the p+3-th row, the scan line of the p+5-th row, and the scan line of the p+7-th row are scanned. That is, the first field and the second field are constituted by scanning every other scan line.

(x-th Frame)

As shown in FIG. 17, in the first field of the x-th frame, the scan line driver circuit 6 selects the scan line of the p-th row, the scan line of the p+2-th row, the scan line of the p+4-th row, and the scan line of the p+6-th row from top to bottom. At this time, the scan line of the p+1-th row, the scan line of the p+3-th row, the scan line of the p+5-th row, and the scan line of the p+7-th row, which are scan lines for the second field, are skipped. Accordingly, the scan line driver circuit 6 scans every second scan line from the scan line of the first row to the scan line of the P-th row.

As shown in FIG. 17, in the first field of the x-th frame, when the scan line driver circuit 6 scans the scan line of the p-th row, the signal line driver circuit 8 supplies data signals of the “+” polarity to the data signal lines of the q-th column, the q+2-th column, and the q+4-th column. The signal line driver circuit 8 supplies data signals of the “−” polarity to the data signal lines of the q+1-th column, the q+3-th column, and the q+5-th column.

In the first field of the x-th frame, when the scan line driver circuit 6 scans the scan line of the p+2-th row, the signal line driver circuit 8 supplies data signals of the “−” polarity to the data signal lines of the q-th column, the q+2-th column, and the q+4-th column. The signal line driver circuit 8 supplies data signals of the “+” polarity to the data signal lines of the q+1-th column, the q+3-th column, and the q+5-th column.

As described above, in the present embodiment, when the scan line driver circuit 6 scans the scan line of the p-th column, the signal line driver circuit 8 applies data signals to subpixels aligned adjacent to each other along the row direction such that the polarities of the data signals are reversed every subpixel. Also, when the scan line driver circuit 6 scans the scan line of the p+2-th column, the signal line driver circuit 8 applies data signals having the opposite polarities to those of the data signals applied when the scan line of the p-th column was scanned.

By the scan line driver circuit 6 and the signal line driver circuit 8 being driven in the manner described above, in the first field of the x-th frame, the polarity of the data signals applied to the (p, q)-th subpixel R and the (p, q+2)-th subpixel B becomes “+” as shown in FIG. 17. The polarity of the data signals applied to the (p+2, q)-th subpixel R, the (p, q+3)-th subpixel R, the (p+2, q+2)-th subpixel B, and the (p, q+5)-th subpixel B becomes “−” as shown in FIG. 17.

Also, as shown in FIG. 17, the polarity of the data signal applied to the (p, q+1)-th subpixel G becomes “−,” and the polarity of the data signals applied to the (p+2, q+1)-th subpixel G and the (p, q+4)-th subpixel G becomes “+.”

Accordingly, the signal line driver circuit 8 is driven such that each subpixel that is defined by each scan line that is selected in the first field is applied with a data signal having the opposite polarity to that of a data signal applied to an adjacent subpixel thereof. Furthermore, the signal line driver circuit 8 is driven such that respective adjacent subpixels out of subpixels that display the same color and that are defined by each scan line that is selected in the first field are applied with data signals having the opposite polarity to each other.

Similarly, in the second field of the x-th frame, the polarity of data signals applied to the (p+1, q)-th subpixel R, and the (p+1, q+2)-th subpixel B becomes “+” as shown in FIG. 17. The polarity of the data signals applied to the (p+3, q)-th subpixel R, the (p+1, q+3)-th subpixel R, the (p+3, q+2)-th subpixel B, and the (p+1, q+5)-th subpixel B becomes “−” as shown in FIG. 17.

Also, as shown in FIG. 17, the polarity of the data signal applied to the (p+1, q+1)-th subpixel G becomes “−,” and the polarity of the data signals applied to the (p+3, q+1)-th subpixel G and the (p, q+4)-th subpixel G becomes “+”.

That is, in each field, the signal line driver circuit 8 causes the polarities of data signals applied to selected pixels to be reversed every subpixel (or in other words, every 1×1 selected pixel group), with respect to the row direction and the column direction, respectively.

(x+1-th Frame)

As shown in FIG. 17, the polarities of the data signals to be applied to the respective subpixels in the first field of the x+1-th frame are opposite to the polarities of the data signals that were applied to the corresponding subpixels in the first field of the x-th frame. The polarities of the data signals to be applied to the respective subpixels in the second field of the x+1-th frame are opposite to the polarities of the data signals that were applied to the corresponding subpixels in the second field of the x-th frame.

As described above, the polarity of data signal to be applied to each pixel that is to be selected in one field is made opposite to the polarity of the data signal that was applied to the pixel in an immediately preceding field to that one field, the immediately preceding field being where the pixel to be selected was previously selected.

(One-line Interlaced Driving, Two-dot Reverse Driving)

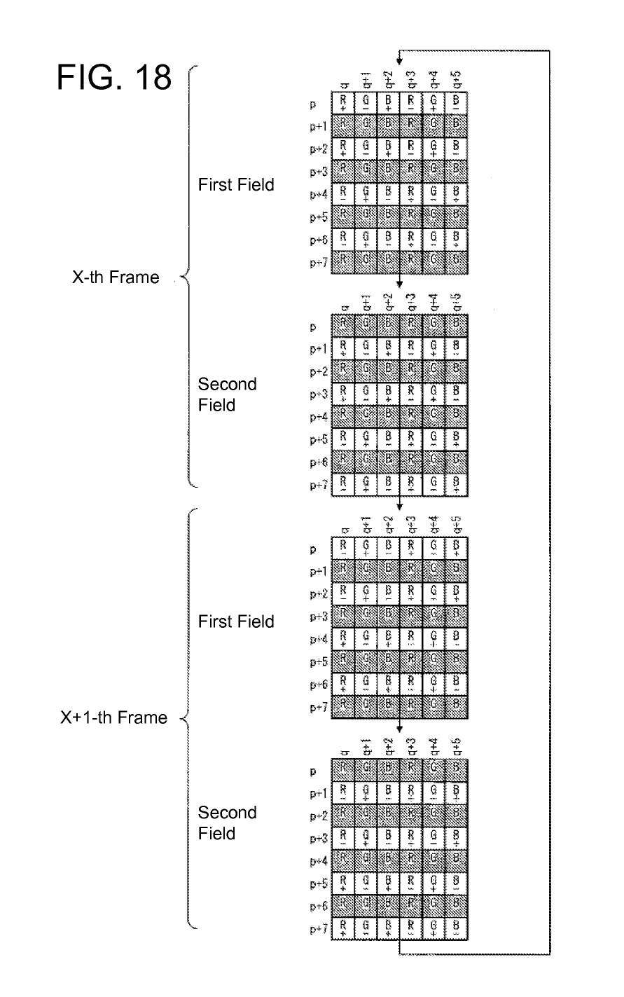

Next, the case in which the one-line interlaced driving (n=1) and the two-dot reverse driving (m=2) are conducted will be explained with reference to FIG. 18. FIG. 18 is a transition diagram schematically showing changes in polarities of respective subpixels when conducting one-line interlaced driving and two-dot reverse driving in the liquid crystal display device 1 of the present embodiment.

As shown in FIG. 18, in the first field of the x-th frame, the scan line driver circuit 6 selects the scan line of the p-th row, the scan line of the p+2-th row, the scan line of the p+4-th row, and the scan line of the p+6-th row from top to bottom. At this time, the scan line of the p+1-th row, the scan line of the p+3-th row, the scan line of the p+5-th row, and the scan line of the p+7-th row, which are scan lines for the second field, are skipped.

Accordingly, the scan line driver circuit 6 scans every second scan line from the scan line of the first row to the scan line of the P-th row. That is, the scan line driver circuit 6 repeatedly conducts scanning on every second scan line of respective scan lines such that each scan line is selected in every other field.

At this time, as shown in FIG. 18, the signal line driver circuit 8 applies data signals to subpixels disposed adjacent to each other along the row direction such that the polarities thereof are reversed every subpixel, and applies data signals to subpixels disposed adjacent to each other along the column direction such that the polarities thereof are reversed every pair of subpixels, in each field. The signal line driver circuit 8 also causes the polarities of data signals to be applied to respective subpixels to be made opposite between every frame.

That is, in each field, the signal line driver circuit 8 causes the polarities of data signals applied to respective selected pixels to be reversed every group of one subpixel in the row direction and two subpixel in the column direction, respectively (or in other words, every 1×2 selected pixel group), with respect to the row direction and the column direction.

Accordingly, as shown in FIG. 18, the polarities of the data signals to be applied to the respective subpixels in the first field of the x+1-th frame are opposite to the polarities of the data signals that were applied to the corresponding subpixels in the first field of the x-th frame. The polarities of the data signals to be applied to the respective subpixels in the second field of the x+1-th frame are opposite to the polarities of the data signals that were applied to the corresponding subpixels in the second field of the x-th frame.

As described above, the polarity of data signal to be applied to each pixel that is to be selected in one field is made opposite to the polarity of the data signal that was applied to the pixel in an immediately preceding field to that one field, the immediately preceding field being where the pixel to be selected was previously selected.

(Two-line Interlaced Driving, One-dot Reverse Driving)

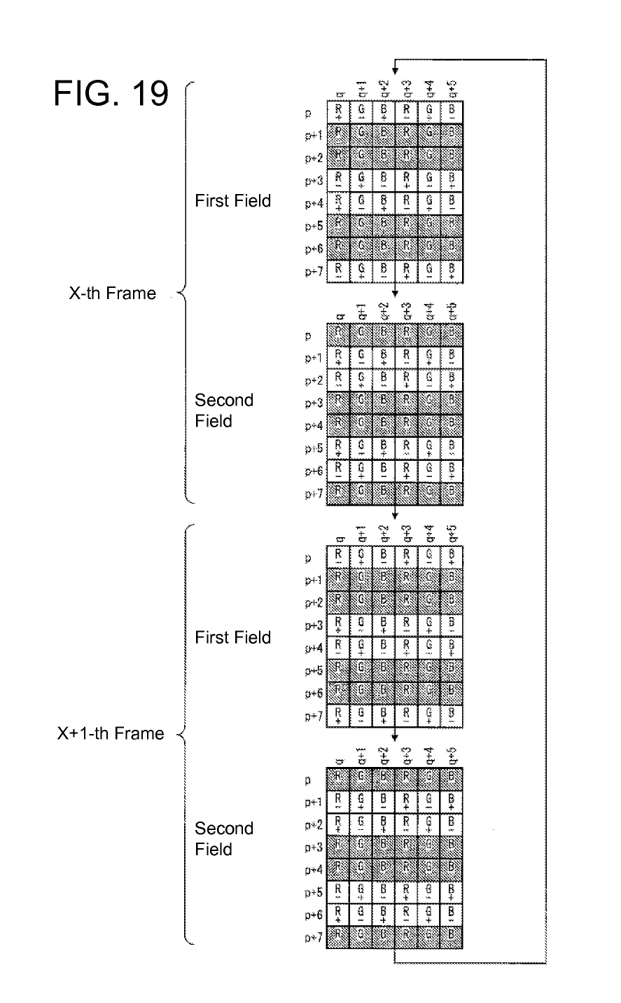

Next, the case in which the two-line interlaced driving (n=2) and the one-dot reverse driving (m=1) are conducted will be explained with reference to FIG. 19. FIG. 19 is a transition diagram schematically showing changes in polarities of respective subpixels when conducting two-line interlaced driving and one-dot reverse driving in the liquid crystal display device 1 of the present embodiment.

As shown in FIG. 19, in the first field of the x-th frame, the scan line driver circuit 6 selects the scan line of the p-th row, the scan line of the p+3-th row, the scan line of the p+4-th row, and the scan line of the p+7-th row from top to bottom. At this time, the scan line of the p+1-th row, the scan line of the p+2-th row, the scan line of the p+5-th row, and the scan line of the p+6-th row, which are scan lines for the second field, are skipped.

In this manner, the scan line driver circuit 6 scans the respective scan lines from the first row to the P-th row, skipping two rows at a time. That is, the scan line driver circuit 6 repeatedly conducts scanning on the respective scan lines, skipping two scan lines at a time, thereby selecting each scan line in every other field.

The signal line driver circuit 8 applies data signals to three subpixels adjacent to each other along the row direction and constituting one main pixel such that the polarities thereof are reversed every subpixel, and also causes the polarities of data signals to be reversed every one of main pixels adjacent to each other along the row direction. Also, the polarities of data signals are reversed every one of subpixels disposed adjacent to each other along the column direction, out of the subpixels that are defined by the scan line scanned in each field.

Accordingly, as shown in FIG. 19, the signal line driver circuit 8 applies data signals to subpixels disposed adjacent to each other in the row direction and the column direction such that the polarities thereof are reversed every subpixel. The signal line driver circuit 8 also causes the polarities of data signals applied to respective subpixels to be made opposite between every frame.

That is, in each field, the signal line driver circuit 8 reverses the polarities of data signals applied to selected pixels every subpixel (or in other words, every 1×1 selected pixel group), with respect to the row direction and the column direction, respectively.

Accordingly, as shown in FIG. 19, the polarities of the data signals to be applied to the respective subpixels in the first field of the x+1-th frame are opposite to the polarities of the data signals that were applied to the corresponding subpixels in the first field of the x-th frame. The polarities of the data signals to be applied to the respective subpixels in the second field of the x+1-th frame are opposite to the polarities of the data signals that were applied to the corresponding subpixels in the second field of the x-th frame.

As described above, the polarity of data signal to be applied to each pixel that is to be selected in one field is made opposite to the polarity of the data signal that was applied to the pixel in an immediately preceding field to that one field, the immediately preceding field being where the pixel to be selected was previously selected.

(Two-Line Interlaced Driving, Two-Dot Reverse Driving)

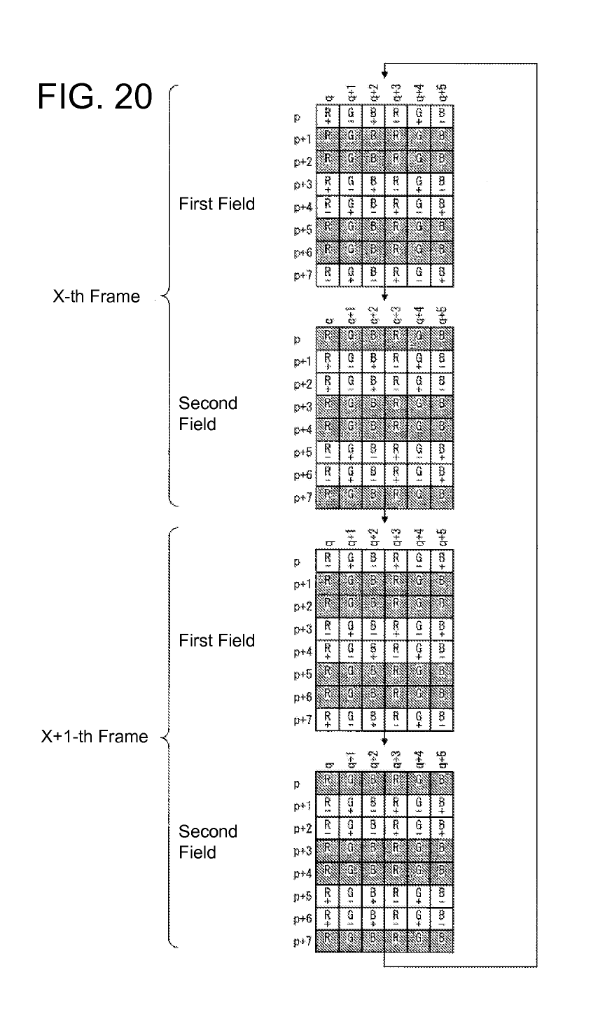

Next, the case in which the two-line interlaced driving (n=2) and the two-dot reverse driving (m=2) are conducted will be explained with reference to FIG. 20. FIG. 20 is a transition diagram schematically showing changes in polarities of respective subpixels when conducting two-line interlaced driving and two-dot reverse driving in the liquid crystal display device 1 of the present embodiment.

As shown in FIG. 20, in the first field of the x-th frame, the scan line driver circuit 6 selects the scan line of the p-th row, the scan line of the p+3-th row, the scan line of the p+4-th row, and the scan line of the p+7-th row from top to bottom. At this time, the scan line of the p+1-th row, the scan line of the p+2-th row, the scan line of the p+5-th row, and the scan line of the p+6-th row, which are scan lines for the second field, are skipped.

In this manner, the scan line driver circuit 6 scans the respective scan lines from the first row to the P-th row, while skipping two scan lines at a time. That is, the scan line driver circuit 6 repeatedly conducts scanning on the respective scan lines, alternately selecting each pair of scan lines, such that each scan line is selected in every other field.

The signal line driver circuit 8 applies data signals to three subpixels adjacent to each other along the column direction and constituting each main pixel such that the polarities thereof are reversed every subpixel, and also causes the polarities of data signals to be reversed every one of main pixels adjacent to each other along the row direction. Also, of the subpixels defined by the scan lines scanned in each field, the polarities of data signals are reversed every two subpixels disposed adjacent to each other along the column direction.

In this manner, as shown in FIG. 20, the signal line driver circuit 8 applies data signals to subpixels disposed adjacent to each other along the row direction such that the polarities thereof are reversed every subpixel, and applies data signals to subpixels disposed adjacent to each other along the column direction such that the polarities thereof are reversed every pair of subpixels. The signal line driver circuit 8 also causes the polarities of data signals applied to respective subpixels to be made opposite between every frame.

That is, in each field, the signal line driver circuit 8 causes the polarities of data signals applied to respective selected pixels to be reversed every group of one subpixel in the row direction and two subpixel in the column direction, respectively (or in other words, every 1×2 selected pixel group), with respect to the row direction and the column direction.

Accordingly, as shown in FIG. 20, the polarities of the data signals to be applied to the respective subpixels in the first field of the x+1-th frame are opposite to the polarities of the data signals that were applied to the corresponding subpixels in the first field of the x-th frame. The polarities of the data signals to be applied to the respective subpixels in the second field of the x+1-th frame are opposite to the polarities of the data signals that were applied to the corresponding subpixels in the second field of the x-th frame.

As described above, the polarity of data signal to be applied to each pixel that is to be selected in one field is made opposite to the polarity of the data signal that was applied to the pixel in an immediately preceding field to that one field, the immediately preceding field being where the pixel to be selected was previously selected.

In the present embodiment, when conducting the two-line interlaced driving and the two-dot reverse driving, the signal line driver circuit 8 was configured such that, with respect to the column direction, the polarities of data signals to be applied to respective subpixels are reversed every pair of two subpixels that are respectively defined by scan lines (such as scan lines of the p-th row and the p+3-th row in FIG. 20, for example) that have therebetween two adjacent rows of scan lines that are skipped in the first field of each frame. However, the present embodiment is not limited thereto.

For example, the signal line driver circuit 8 may be configured such that, with respect to the column direction, the polarities of data signals to be applied to respective subpixels are reversed every pair of two adjacent subpixels that are defined by scan lines disposed between two rows of scan lines that are skipped in the first field of each frame. In other words, with respect to the column direction, the signal line driver circuit 8 causes the polarities of data signals applied to the respective subpixels to be reversed every pair of adjacent subpixels that are defined by scan lines disposed between two rows of scan lines that are skipped in the first field of each frame.

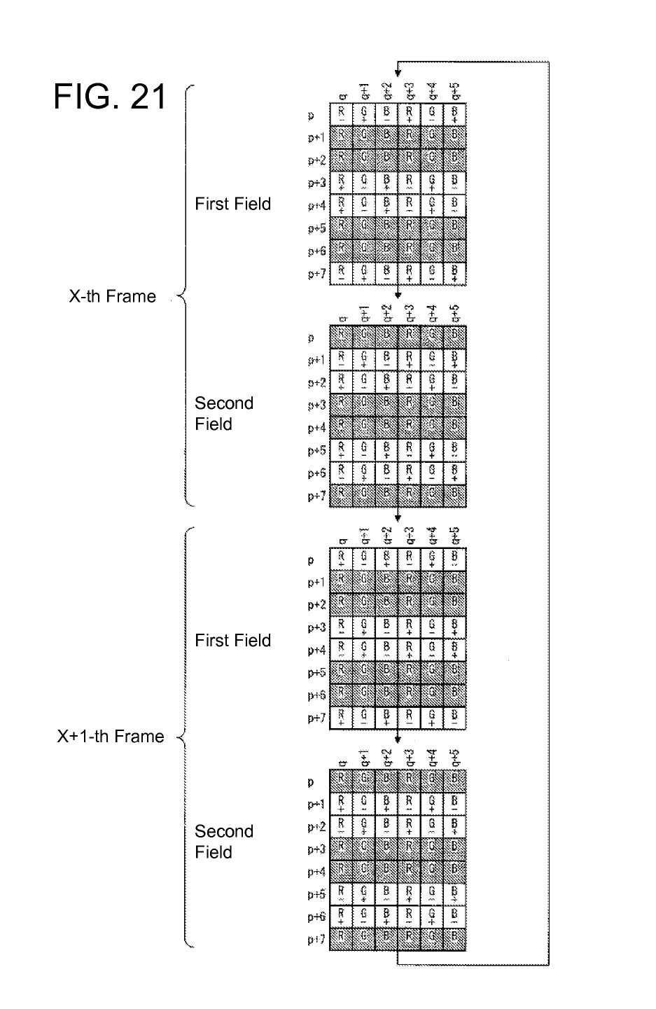

With reference to FIG. 21, an example will be explained in which, when conducting the two-line interlaced driving and the two-dot reverse driving, the polarities of data signals to be applied to respective subpixels are reversed every pair of two adjacent subpixels that are defined by scan lines disposed between two rows of scan lines that are skipped in the first field of each frame. FIG. 9 is a transition diagram schematically showing changes in polarities of respective subpixels when the polarities of data signals to be applied to respective subpixels are reversed every pair of two adjacent subpixels that are defined by scan lines disposed between two rows of scan lines that are skipped in the first field of each frame, in the case in which two-line interlaced driving and two-dot reverse driving are conducted in the liquid crystal display device 1 of the present embodiment.

As shown in FIG. 21, the scan line driver circuit 6 conducts the two-line interlaced driving by scanning the scan line of the p-th row, the scan line of the p+3-th row, the scan line of the p+4-th row, and the scan line of the p+7-th row from top to bottom in the first field of the x-th frame. The scan line of the p+2-th row, the scan line of the p+3-th row, the scan line of the p+5-th row, and the scan line of the p+6-th row, which are scan lines for the second field, are skipped.

In this manner, the scan line driver circuit 6 scans the respective scan lines from the first row to the P-th row, skipping two scan lines at a time. That is, the scan line driver circuit 6 repeatedly conducts scanning on the respective scan lines, alternately selecting each pair of scan lines, such that each scan line is selected every other field.

The signal line driver circuit 8 applies data signals to three subpixels adjacent to each other along the tow direction and constituting each main pixel such that the polarities thereof are reversed every subpixel, and also causes the polarities of data signals to be reversed every one of main pixels adjacent to each other along the row direction. Also, the signal line driver circuit 8 causes the polarities of data signals to be reversed every two adjacent subpixels that are defined by scan lines that are adjacent to each other along the column direction between two rows of scan lines that are skipped and not scanned.

That is, as shown in FIG. 21, the signal line driver circuit 8 applies data signals to subpixels disposed adjacent to each other along the row direction such that the polarities thereof are reversed every subpixel, and applies data signals to subpixels disposed adjacent to each other along the column direction such that the polarities thereof are reversed every pair of subpixels. The signal line driver circuit 8 also causes the polarities of data signals applied to respective subpixels to be reversed every frame.

Accordingly, as shown in FIG. 21, the polarities of the data signals to be applied to the respective subpixels in the first field of the x+1-th frame are opposite to the polarities of the data signals that were applied to the corresponding subpixels in the first field of the x-th frame. The polarities of the data signals to be applied to the respective subpixels in the second field of the x+1-th frame are opposite to the polarities of the data signals that were applied to the corresponding subpixels in the second field of the x-th frame.

As described above, the polarity of data signal to be applied to each pixel that is to be selected in one field is made opposite to the polarity of the data signal that was applied to the pixel in an immediately preceding field to that one field, the immediately preceding field being where the pixel to be selected was previously selected.

### Modification Example

In the present embodiment, each main pixel may be constituted of two subpixels, and a configuration in which two subpixels constituting each main pixel are aligned in a row along the row direction may be employed. Below, the modification example of the present embodiment will be explained.

(Configuration of Pixels)

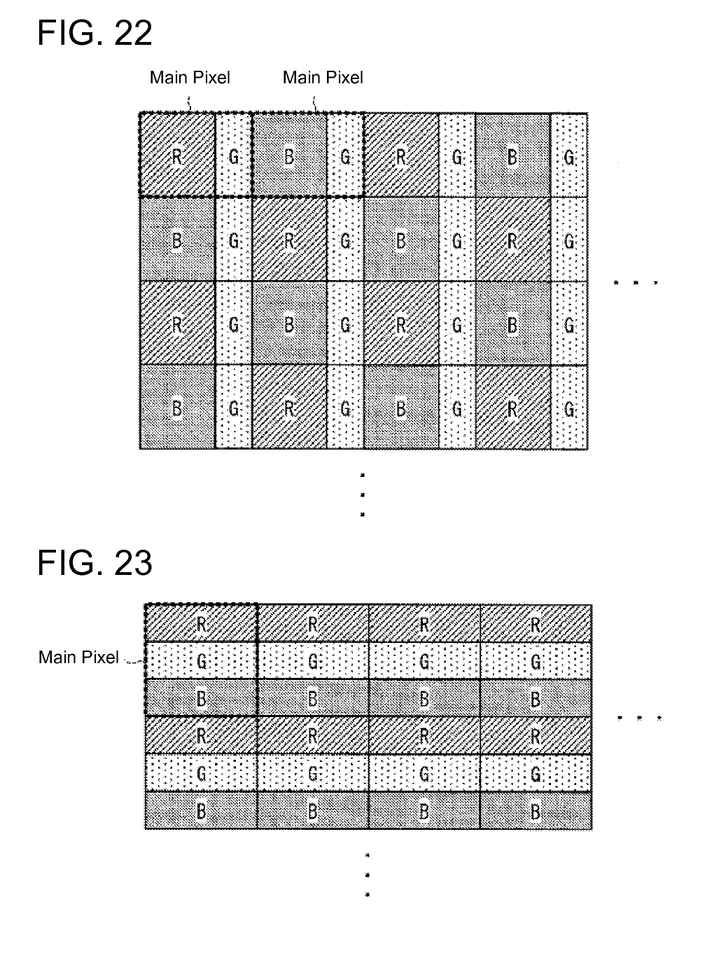

An arrangement of two subpixels that constitute a main pixel in the display panel 2 of the liquid crystal display device 1 of this modification example will be explained with reference to FIG. 22. FIG. 22 shows the arrangement of two subpixels constituting each main pixel of the display panel 2 in the liquid crystal display device 1 of this modification example.

As shown in FIG. 22, one main pixel is constituted of two subpixels of a subpixel R and a subpixel G, and the other main pixel that is adjacent to the one pixel is constituted of two subpixels of a subpixel B and a subpixel G. That is, a main pixel is constituted of a subpixel (first pixel) that displays a color differing from that in the other main pixel adjacent thereto, and a subpixel (second pixel) that displays the same color in any main pixel. The size of the subpixel R and the subpixel B is approximately twice the size of the subpixel G.

In the present embodiment, the example in which the size of the subpixel R and the subpixel B is approximately twice the size of the subpixel G will be explained, but the present invention is not limited thereto. For example, the size of the subpixel R and the subpixel G may be approximately twice the size of the subpixel B, or the size of the subpixel G and the subpixel B may be approximately twice the size of the subpixel R.

In this modification example, the example in which two subpixels constituting a main pixel are disposed adjacent to each other along the row direction was described, but the present invention in not limited thereto. A configuration in which two subpixels are disposed adjacent to each other along the column direction may also be employed.

It is also possible to describe the configuration of each subpixel in this modification example as follows: two subpixels constitute each main pixel; two subpixels constituting each main picture element respectively display two colors out of three primary colors; and four subpixels that constitute two adjacent main picture elements include three subpixels that respectively display three primary colors.

(Two-Line Interlaced Driving, Two-Dot Reverse Driving)

Below, an example will be explained in which the two-line interlaced driving and the two-dot reverse driving are conducted in the liquid crystal display device 1 shown in FIG. 22.

In the first field of the x-th frame, the scan line driver circuit 6 scans the scan line of the first row, the scan line of the fourth row, and the scan line of the fifth row (not shown) from top to bottom in FIG. 22. The scan line of the second row and the scan line of the third row, which are scan lines for the second field, are skipped.

Accordingly, the scan line driver circuit 6 scans from the scan line of the first row to the scan line of the P-th row, while skipping two rows at a time. That is, the scan line driver circuit 6 repeatedly conducts scanning on the respective scan lines, alternately selecting each pair of scan lines, such that each scan line is selected every other field.

The signal line driver circuit 8 applies data signals of the same polarity to respective two subpixels disposed adjacent to each other along the row direction, and reverses the polarities of data signals every one of main pixels adjacent to each other along the row direction. Also, out of the subpixels that are defined by the scan lines scanned in each field, the polarities of data signals are reversed every pair of subpixels adjacent to each other in the column direction.

In this manner, the signal line driver circuit 8 reverses the polarities of data signals every one of main pixels disposed adjacent to each other along the row direction, and applies data signals to subpixels disposed adjacent to each other along the column direction such that the polarities thereof are reversed every pair of subpixels. The signal line driver circuit 8 causes the polarities of data signals applied to respective subpixels to be opposite between every frame.

That is, in each field, the signal line driver circuit 8 causes the polarities of data signals applied to respective selected pixels to be reversed every two subpixels in the row direction and every two subpixels in the column direction (or in other words, every 2×2 selected pixel group), with respect to the row direction and the column direction, respectively.

Accordingly, the polarities of the data signals to be applied to the respective subpixels in the first field of the x+1-th frame are opposite to the polarities of the data signals that were applied to the corresponding subpixels in the first field of the x-th frame. The polarities of the data signals to be applied to the respective subpixels in the second field of the x+1-th frame are opposite to the polarities of the data signals that were applied to the corresponding subpixels in the second field of the x-th frame.

As described above, the polarity of data signal to be applied to each pixel that is to be selected in one field is made opposite to the polarity of the data signal that was applied to the pixel in an immediately preceding field to that one field, the immediately preceding field being where the pixel to be selected was previously selected.

As described above, the respective subpixels are configured such that each main pixel is constituted of two subpixels along each scan line. Of the subpixels constituting the respective main pixels, subpixels that display the same color in any main pixel display the same one color out of the three primary colors in any picture element, and subpixels that display a color differing from that of an main pixel adjacent thereto alternately display two colors of the three primary colors, other than the color displayed by the second pixels. Therefore, with the above-mentioned configuration, it is possible to display a color image by mixing three colors, while suppressing the power consumption and the occurrence of flickering.

### Embodiment 4

In Embodiment 1, the example in which four subpixels constituting each main pixel have two pixels aligned in the column direction and two pixels aligned in the row direction, respectively, was described, but the present invention is not limited thereto. For example, a main pixel may be constituted of three subpixels, and a configuration in which three subpixels constituting each main pixel are aligned in a row along the column direction may be employed.

(Configuration of Pixels)

With reference to FIG. 23, the arrangement of three subpixels constituting each main pixel of the display panel 2 in the liquid crystal display device 1 of the present embodiment will be explained. FIG. 23 shows the arrangement of three subpixels constituting each main pixel of the display panel 2 in the liquid crystal display device 1 of the present embodiment.

A liquid crystal display device of yet another embodiment of the present invention will be explained with reference to FIGS. 23 to 27.

As shown in FIG. 23, one main pixel is constituted of three subpixels of a subpixel R, a subpixel G, and a subpixel B. The three subpixels are aligned in a row along the column direction, and as shown in FIG. 23, for example, the subpixel R, the subpixel G, and the subpixel B are arranged adjacent to each other in this order along the column direction.

In the present embodiment, an example will be explained in which the subpixel R, the subpixel G, and the subpixel B are arranged in this order adjacent to each other along the row direction, but the present invention is not limited thereto. The three subpixels can be arranged in six different ways, which is the factorial of three, and for example, the three subpixels may be arranged such that the subpixel R, the subpixel B, and the subpixel G are adjacent to each other in this order along the row direction.

(One-Line Interlaced Driving, One-Dot Reverse Driving)

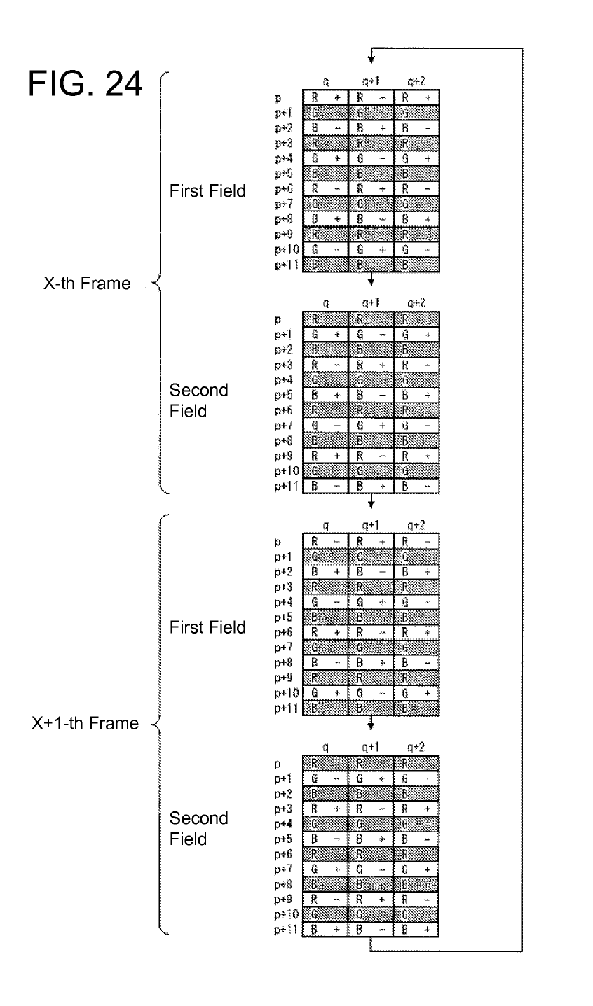

First, the case in which the one-line interlaced driving (n=1) and the one-dot reverse driving (m=1) are conducted will be explained with reference to FIG. 24. FIG. 24 is a transition diagram schematically showing changes in polarities of respective subpixels when conducting one-line interlaced driving and one-dot reverse driving in the liquid crystal display device 1 of the present embodiment.

In order to conduct the one-line interlaced driving, as shown in FIG. 24, in the first field, the scan lines of the p-th row, the p+2-th row, the p+4-th row, the p+6-th row, the p+8-th row, and the p+10-th row are scanned. In the second field, the scan lines of the p+1-th row, the p+3-th row, the p+5-th row, the p+7-th row, the p+9-th row, and the p+11-th row are scanned. That is, the first field and the second field are constituted by scanning every other scan line.

(x-th Frame)

As shown in FIG. 24, in the first field of the x-th frame, the scan line driver circuit 6 selects the scan line of the p-th row, the p+2-th row, the p+4-th row, the p+6-th row, the p+8-th row, and the p+10-th row from top to bottom. The scan lines of the p+1-th row, the p+3-th row, the p+5-th row, the p+7-th row, the p+9-th row, and the p+11-th row, which are the scan lines for the second field, are skipped. In this manner, the scan line driver circuit 6 scans every second scan line from the scan line of the first row to the scan line of the P-th row.

As shown in FIG. 24, in the first field of the x-th frame, when the scan line driver circuit 6 scans the scan line of the p-th row, the signal line driver circuit 8 supplies data signals having the “+” polarity to the data signal lines of the q-th column and the q+2-th column. The signal line driver circuit 8 supplies a data signal of the “−” polarity to the data signal line of the q+1-th column.

In the first field of the x-th frame, when the scan line driver circuit 6 scans the scan line of the p+2-th row, the signal line driver circuit 8 supplies data signals of the “−” polarity to the data signal lines of the q-th column and the q+2-th column. The signal line driver circuit 8 also supplies a data signal of the “+” polarity to the data signal line of the q+1-th column.

As described above, in the present embodiment, when the scan line driver circuit 6 scans the scan line of the p-th row, the signal line driver circuit 8 applies data signals to subpixels disposed adjacent to each other along the row direction such that the polarities thereof are reversed every subpixel. Also, when the scan line driver circuit 6 scans the scan line of the p+2-th row, the signal line driver circuit 8 applies data signals having the opposite polarities to those of the data signals applied when the scan line of the p-th row was scanned.

By the scan line driver circuit 6 and the signal line driver circuit 8 being driven in the manner described above, in the first field of the x-th frame, the polarity of the data signal applied to the (p, q)-th subpixel R and the (p+4, q)-th subpixel G becomes “+” as shown in FIG. 24. The polarity of the data signals applied to the (p+6, q)-th subpixel R, the (p, q+1)-th subpixel R, the (p+10, q)-th subpixel G, and the (p+4, q+2)-th subpixel G becomes “−” as shown in FIG. 24.

Also, as shown in FIG. 24, the polarity of the data signal applied to the (p+2, q)-th subpixel B becomes “−”, and the polarity of the data signals applied to the (p+8, q)-th subpixel B and the (p+2, q+2)-th subpixel B becomes “+.”

Accordingly, the signal line driver circuit 8 is driven such that each subpixel that is defined by each scan line that is selected in each field is applied with a data signal having the opposite polarity to that of a data signal applied to an adjacent subpixel thereof. Furthermore, the signal line driver circuit 8 is driven such that, out of subpixels that display the same color and that are defined by scan lines that are selected in each field, respective adjacent subpixels are applied with data signals having the opposite polarity to each other.

Similarly, in the second field of the x-th frame, the polarity of data signals applied to the (p+1, q)-th subpixel G and the (p+5, q)-th subpixel B becomes “+” as shown in FIG. 24. The polarity of the data signals applied to the (p+7, q)-th subpixel G, the (p+11, q)-th subpixel G, the (p+1, q+1)-th subpixel G, and the (p+5, q+1)-th subpixel B becomes “−” as shown in FIG. 24.

Also, as shown in FIG. 24, the polarity of the data signal applied to the (p+3, q)-th subpixel R becomes “−,” and the polarity of the data signals applied to the (p+9, q)-th subpixel R and the (p+3, q+1)-th subpixel R becomes “+.”

That is, in each field, the signal line driver circuit 8 causes the polarities of data signals applied to selected pixels to be reversed every subpixel (or in other words, every 1×1 selected pixel group), with respect to the row direction and the column direction, respectively.

(x+1-th Frame)

As shown in FIG. 24, the polarities of the data signals to be applied to the respective subpixels in the first field of the x+1-th frame are opposite to the polarities of the data signals that were applied to the corresponding subpixels in the first field of the x-th frame. The polarities of the data signals to be applied to the respective subpixels in the second field of the x+1-th frame are opposite to the polarities of the data signals that were applied to the corresponding subpixels in the second field of the x-th frame.

As described above, the polarity of data signal to be applied to each pixel that is to be selected in one field is made opposite to the polarity of the data signal that was applied to the pixel in an immediately preceding field to that one field, the immediately preceding field being where the pixel to be selected was previously selected.

(One-Line Interlaced Driving, Three-Dot Reverse Driving)

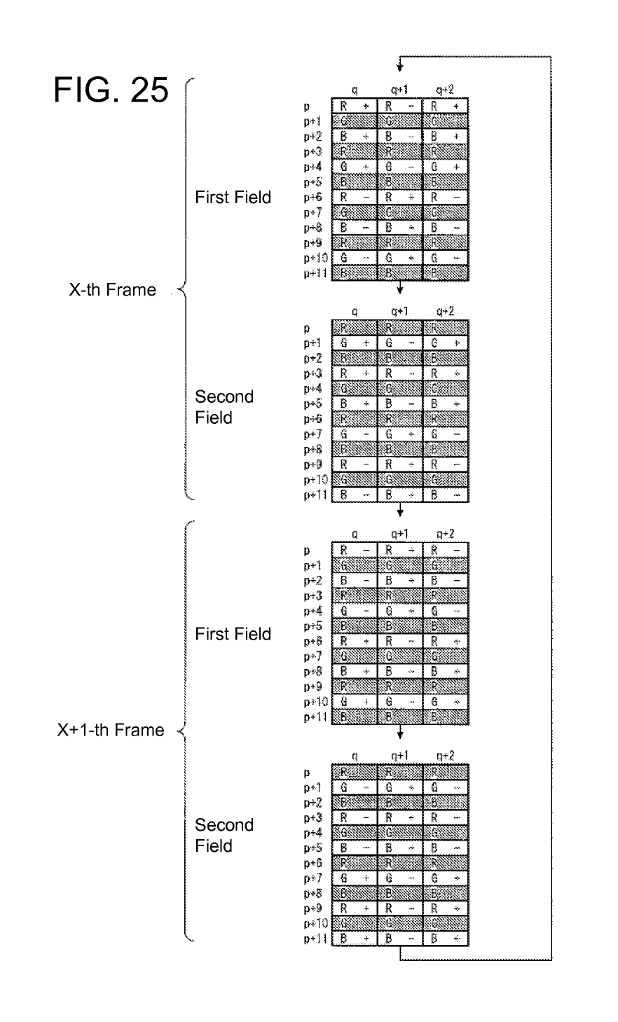

Next, the case in which the one-line interlaced driving (n=1) and the three-dot reverse driving (m=3) are conducted will be explained with reference to FIG. 25. FIG. 25 is a transition diagram schematically showing changes in polarities of respective subpixels when conducting one-line interlaced driving and three-dot reverse driving in the liquid crystal display device 1 of the present embodiment.

As shown in FIG. 25, in the first field of the x-th frame, the scan line driver circuit 6 selects the scan lines of the p-th row, the p+2-th row, the p+4-th row, the p+6-th row, the p+8-th row, and the p+10-th row from top to bottom. The scan lines of the p+1-th row, the p+3-th row, the p+5-th row, the p+7-th row, the p+9-th row, and the p+11-th row, which are the scan lines for the second field, are skipped.

In this manner, the scan line driver circuit 6 scans every second scan line from the scan line of the first row to the scan line of the P-th row. That is, the scan line driver circuit 6 repeatedly conducts scanning on every second scan line of respective scan lines such that each scan line is selected in every other field.

At this time, as shown in FIG. 25, the signal line driver circuit 8 applies data signals to subpixels disposed adjacent to each other along the row direction such that the polarities thereof are reversed every subpixel, and applies data signals to subpixels disposed adjacent to each other along the column direction such that the polarities thereof are reversed every group of three subpixels, in each field. The signal line driver circuit 8 also causes the polarities of data signals applied to respective subpixels to be made opposite between every frame.

That is, in each field, the signal line driver circuit 8 causes the polarities of data signals applied to respective selected pixels to be reversed every group of one subpixel in the row direction and three subpixels in the column direction (or in other words, every 1×3 selected pixel group), with respect to the row direction and the column direction, respectively.

Accordingly, as shown in FIG. 25, the polarities of the data signals to be applied to the respective subpixels in the first field of the x+1-th frame are opposite to the polarities of the data signals that were applied to the corresponding subpixels in the first field of the x-th frame. The polarities of the data signals to be applied to the respective subpixels in the second field of the x+1-th frame are opposite to the polarities of the data signals that were applied to the corresponding subpixels in the second field of the x-th frame.

As described above, the polarity of data signal to be applied to each pixel that is to be selected in one field is made opposite to the polarity of the data signal that was applied to the pixel in an immediately preceding field to that one field, the immediately preceding field being where the pixel to be selected was previously selected.

(Three-Line Interlaced Driving, One-Dot Reverse Driving)

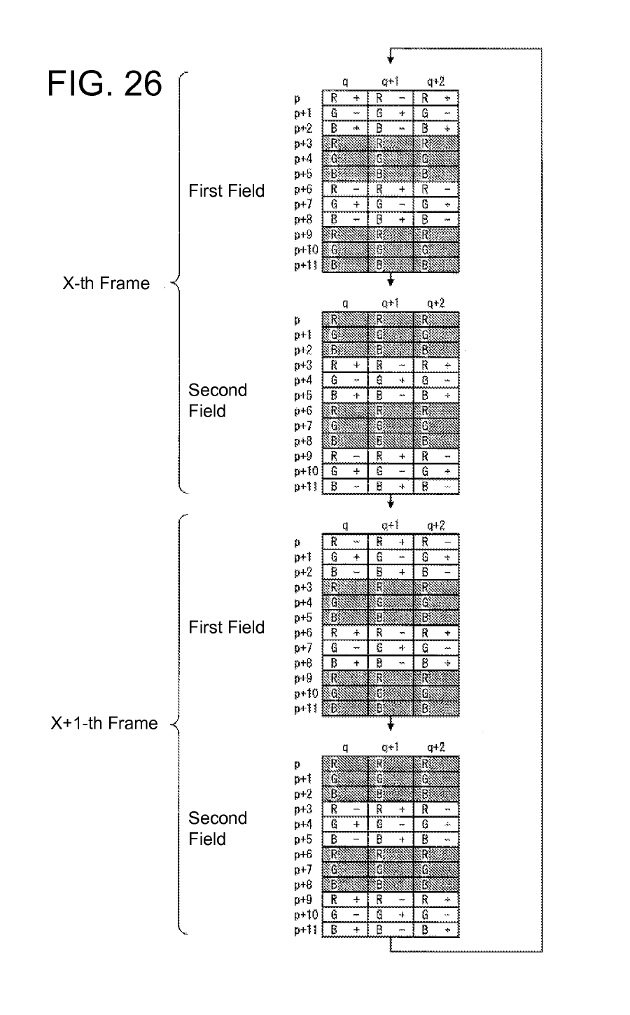

Next, the case in which the three-line interlaced driving (n=3) and the one-dot reverse driving (m=1) are conducted will be explained with reference to FIG. 26. FIG. 26 is a transition diagram schematically showing changes in polarities of respective subpixels when conducting three-line interlaced driving and one-dot reverse driving in the liquid crystal display device 1 of the present embodiment.

As shown in FIG. 26, in the first field of the x-th frame, the scan line driver circuit 6 selects the scan lines of the p-th row, the p+1-th row, the p+2-th row, the p+6-th row, the p+7-th row, and the p+8-th row from top to bottom. The scan lines of the p+3-th row, the p+4-th row, the p+5-th row, the p+9-th row, the p+10-th row, and the p+11-th row, which are the scan lines for the second field, are skipped.

In this manner, the scan line driver circuit 6 alternately scans each group of three scan lines from the scan line of the first row to the scan line of the P-th row. That is, the scan line driver circuit 6 repeats alternate scanning on each group of three scan lines of respective scan lines such that each scan line is selected in every other field.

The signal line driver circuit 8 applies data signals to three subpixels adjacent to each other along the column direction and constituting each main pixel such that the polarities thereof are reversed every subpixel, and also reverses the polarities of data signals every one of subpixels adjacent to each other along the row direction. Also, the polarities of data signals to be applied to subpixels defined by the scan lines that are scanned in each field are reversed every one of main pixels disposed adjacent to each other in the column direction.

Accordingly, as shown in FIG. 26, the signal line driver circuit 8 applies data signals to subpixels disposed adjacent to each other in the row direction and in the column direction such that the polarities thereof are reversed every subpixel. The signal line driver circuit 8 also causes the polarities of data signals applied to respective subpixels to be made opposite between every frame.

That is, in each field, the signal line driver circuit 8 causes the polarities of data signals applied to selected pixels to be reversed every subpixel (or in other words, every 1×1 selected pixel group), with respect to the row direction and the column direction, respectively.

Accordingly, as shown in FIG. 26, the polarities of the data signals to be applied to the respective subpixels in the first field of the x+1-th frame are opposite to the polarities of the data signals that were applied to the corresponding subpixels in the first field of the x-th frame. The polarities of the data signals to be applied to the respective subpixels in the second field of the x+1-th frame are opposite to the polarities of the data signals that were applied to the corresponding subpixels in the second field of the x-th frame.

As described above, the polarity of data signal to be applied to each pixel that is to be selected in one field is made opposite to the polarity of the data signal that was applied to the pixel in an immediately preceding field to that one field, the immediately preceding field being where the pixel to be selected was previously selected.

(Three-Line Interlaced Driving, Three-Dot Reverse Driving)

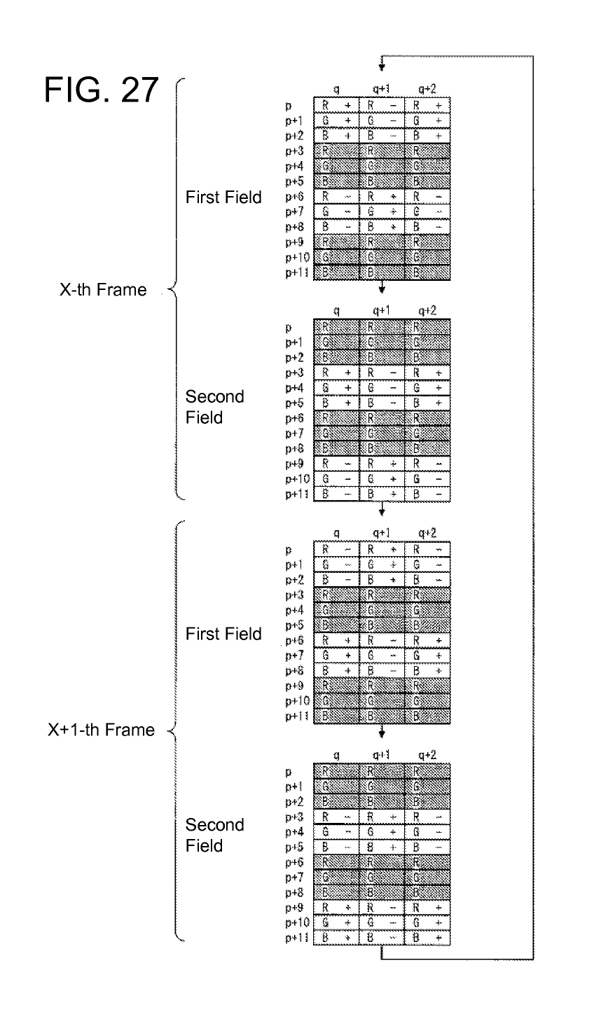

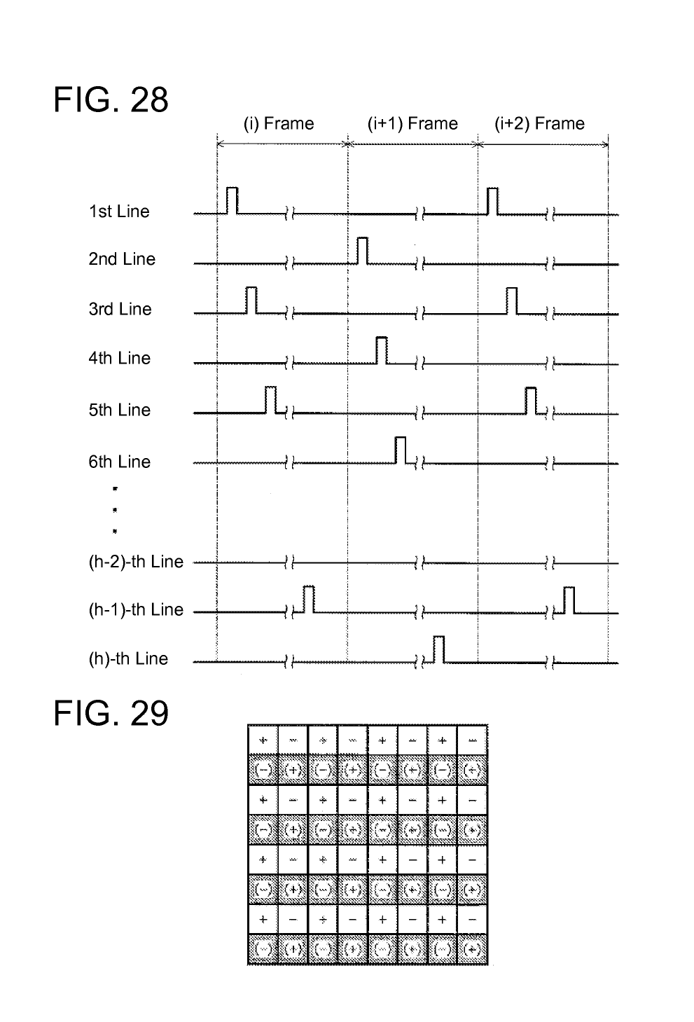

Next, the case in which the three-line interlaced driving (n=3) and the three-dot reverse driving (m=3) are conducted will be explained with reference to FIG. 27. FIG. 27 is a transition diagram schematically showing changes in polarities of respective subpixels when conducting three-line interlaced driving and three-dot reverse driving in the liquid crystal display device 1 of the present embodiment.

As shown in FIG. 27, in the first field of the x-th frame, the scan line driver circuit 6 selects the scan lines of the p-th row, the p+1-th row, the p+2-th row, the p+6-th row, the p+7-th row, and the p+8-th row from top to bottom. The scan lines of the p+3-th row, the p+4-th row, the p+5-th row, the p+9-th row, the p+10-th row, and the p+11-th row, which are the scan lines for the second field, are skipped.

In this manner, the scan line driver circuit 6 alternately scans each set of three scan lines from the scan line of the first row to the scan line of the P-th row. That is, the scan line driver circuit 6 repeats alternate scanning on each set of three scan lines of respective scan lines such that each scan line is selected in every other field.

At this time, the signal line driver circuit 8 applies data signals of the same polarity to three subpixels adjacent to each other along the column direction and constituting each main pixel, and also causes the polarities of data signals to be reversed every one of subpixels adjacent to each other along the row direction. Also, the polarities of data signals to be applied to subpixels defined by the scan lines that are scanned in each field are reversed every one of main pixels disposed adjacent to each other in the column direction.

That is, as shown in FIG. 27, the signal line driver circuit 8 applies data signals of the same polarity to subpixels disposed adjacent to each other along the column direction and constituting the same main pixel, and reverses the polarities of data signals every main pixel. With respect to the subpixels in the row direction, the signal line driver circuit 8 causes the polarities of data signals to be reversed every subpixel.

That is, in each field, the signal line driver circuit 8 causes the polarities of data signals applied to selected pixels to be reversed every group of one subpixel in the row direction and three subpixels in the column direction (or in other words, every 1×3 selected pixel group), with respect to the row direction and the column direction, respectively.

Accordingly, as shown in FIG. 27, the polarities of the data signals to be applied to the respective subpixels in the first field of the x+1-th frame are opposite to the polarities of the data signals that were applied to the corresponding subpixels in the first field of the x-th frame. The polarities of the data signals to be applied to the respective subpixels in the second field of the x+1-th frame are opposite to the polarities of the data signals that were applied to the corresponding subpixels in the second field of the x-th frame.

As described above, the polarity of data signal to be applied to each pixel that is to be selected in one field is made opposite to the polarity of the data signal that was applied to the pixel in an immediately preceding field to that one field, the immediately preceding field being where the pixel to be selected was previously selected.

(Characteristics of TFT Using Oxide Semiconductor)

Although the switching element was not limited to any particular element in Embodiments 1 to 4, it is possible to employ, as the switching element, a switching element that has a semiconductor layer made of a so-called oxide semiconductor. Examples of the oxide semiconductor include IGZO (InGaZnOx).

The switching element using the oxide semiconductor has approximately 20 to 50 times higher electron mobility in the ON state, which results in excellent ON characteristics, as compared with the switching element using a-Si. Therefore, it is possible to achieve the frame frequency of 16.7 ms or less, or in other words, the refresh rate of 60 Hz or more with ease.

In the display panel 2 used in the liquid crystal display device 1 of Embodiments 1 to 4, by using such a switching element that uses the oxide semiconductor and that therefore has excellent ON characteristics for each pixel, it is possible to drive each pixel with a smaller switching element. As a result, in the display panel 2, the area of the switching element in each pixel can be reduced. That is, the aperture ratio in each pixel can be improved, and the transmittance of backlight can be increased. Because this allows a backlight with low power consumption to be used, or allows the brightness of a backlight to be reduced, a reduction in power consumption can be achieved.

Also, because of the excellent ON characteristics of the switching element, the write-in time of the source signals into respective pixels can be reduced, and therefore, it is possible to reduce the frame frequency of the display panel 2 with ease (or in other words, to increase the refresh rate with ease).

The switching element using the oxide semiconductor has an OFF leak current of about 1/100 of that of a switching element using a-Si, resulting in almost no leak current, thus achieving excellent OFF characteristics. Because of the excellent OFF characteristics, it is possible to achieve the frame frequency of 33 ms or more, or the refresh rate of 30 Hz of less with ease.

In the display panel 2 of Embodiments 1 to 4, by using such a switching element made of the oxide semiconductor and having excellent OFF characteristics for each pixel, it is possible to maintain the state in which the source signals are written in the plurality of pixels in the display panel 2 for a long period of time, and therefore, the frame frequency of the display panel 2 can be increased with ease (or in other words, the refresh rate can be reduced with ease).

(Additional Notes)

As described above, a display device according to one embodiment of the present invention includes: a display panel including a plurality of gate lines, a plurality of data lines disposed to intersect with the plurality of gate lines, and a plurality of pixels disposed for respective intersections of the plurality of gate lines and the plurality of data lines; a gate line driver circuit that supplies gate signals to the plurality of gate lines; a data line driver circuit that supplies data signals to the plurality of data lines; and a controller that controls the gate signals and the data signals by using an interlaced driving method in which one frame is constituted of a plurality of fields, wherein the controller causes polarities of data signals applied to selected pixels that are to be selected in one field to be reversed every prescribed number of the selected pixels in a direction along the gate lines and to be reversed every prescribed number of the selected pixels in a direction along the data lines, respectively, and wherein, in the one field, the controller also causes the polarity of data signal applied to each pixel to be selected to be opposite to the polarity of the data signal that was applied to the pixel to be selected in an immediately preceding field to that one field, the immediately preceding field being where the pixel to be selected was selected.

With this configuration, the controller controls the gate line driver circuit and the data line driver circuit such that the gate signals and the data signals are supplied by using interlaced driving method in which one frame is constituted of a plurality of fields. Therefore, with this configuration, power consumption can be reduced as compared with a configuration that does not use the interlaced driving method.

The controller controls the data line driver circuit such that the polarities of data signals applied to selected pixels that are to be selected in one field are reversed every prescribed number of the selected pixels in a direction along the gate lines and every prescribed number of the selected pixels in a direction along the data lines, respectively. With this configuration, the occurrence of flickering can be suppressed.

The controller also controls the data line driver circuit such that the polarity of data signal applied to each pixel to be selected in one field is made opposite to the polarity of the data signal that was applied to the pixel to be selected in an immediately preceding field to that one field, the immediately preceding field being where the pixel to be selected was previously selected. With this configuration, burn-in of the pixels can be prevented.

As described above, with the above-mentioned configuration, it is possible to suppress the occurrence of flickering while keeping power consumption low.

The selected pixels refer to the pixels that are defined by gate lines that receive the gate signal in one field. For example, when using the interlaced driving method in which one frame is constituted of a total of two fields, which are the first field of applying the gate signal to the odd gate lines and the second field of applying the gate signal to the even gate lines, selected pixels that are to be selected in the first field refer to the pixels that are defined by the odd gate lines, and selected pixels that are to be selected in the second field refer to the pixels that are defined by the even gate lines.

When the prescribed number in the direction along the gate lines is NG, and the prescribed number in the direction along the data lines is ND, the controller causes the polarities of data signals to be reversed every group of NG×ND selected pixels. When NG=1 and ND=1, for example, the controller conducts dot reverse driving for every selected pixel in respective fields that constitute one frame. When NG=2 and ND=2, the controller conducts polarity reversal driving for every 2×2 selected pixel group in respective fields that constitute one frame.

In the display device of one embodiment of the present invention, it is preferable that the plurality of pixels be configured such that each set of four pixels with two aligned along the gate lines and two aligned along the data lines constitutes a picture element, and the four pixels constituting each picture element respectively display three primary colors and one color that is obtained by combining at least one of the three primary colors.

With this configuration, the plurality of pixels are configured such that each set of four pixels with two aligned along the gate lines and two aligned along the data lines constitutes a picture element, and the four pixels constituting each picture element respectively display three primary colors and one color that is different from any of the three primary colors. Therefore, with the above-mentioned configuration, it is possible to display a color image by mixing four colors, while suppressing the power consumption and flickering.

Examples of the three primary colors are red, green, and blue, and examples of the one color that is obtained by combining at least one of the three primary colors include white and yellow. The one color that is obtained by combining at least one of the three primary colors may be one of red, green, and blue.

In the display device of an embodiment of the present invention, it is preferable that the plurality of pixels be configured such that each set of four pixels aligned along the gate lines constitutes a picture element, and the four pixels constituting each picture element respectively display three primary colors and one color that is different from any one of the three primary colors.

With this configuration, the plurality of pixels are configured such that each set of four pixels aligned along the gate lines constitutes a picture element, and the four pixels constituting each picture element respectively display three primary colors and one color that is different from any one of the three primary colors. Therefore, with the above-mentioned configuration, it is possible to display a color image by mixing four colors, while suppressing the power consumption and flickering.

Examples of the three primary colors are red, green, and blue, and examples of the one color that is obtained by combining at least one of the three primary colors include white and yellow. The one color that is obtained by combining at least one of the three primary colors may be one of red, green, and blue.

In the display device of an embodiment of the present invention, it is preferable that the plurality of pixels be configured such that each set of three pixels aligned along the gate lines constitutes a picture element, and the three pixels constituting each picture element respectively display three primary colors.

With this configuration, the plurality of pixels are configured such that each set of three pixels aligned along the gate lines constitutes a picture element, and the three pixels constituting each picture element respectively display three primary colors. Therefore, with the above-mentioned configuration, it is possible to display a color image by mixing three colors, while suppressing the power consumption and flickering.

Examples of the three primary colors include red, green, and blue.

In the display device of an embodiment of the present invention, it is preferable that the plurality of pixels be configured such that each set of three pixels aligned along the data lines constitutes a picture element, and the three pixels constituting each picture element respectively display three primary colors.

With this configuration, the plurality of pixels are configured such that each set of three pixels aligned along the data lines constitutes a picture element, and the three pixels constituting each picture element respectively display three primary colors. Therefore, with the above-mentioned configuration, it is possible to display a color image by mixing three colors, while suppressing the power consumption and flickering.

Examples of the three primary colors include red, green, and blue.

In the display device of one embodiment of the present invention, it is preferable that the plurality of pixels be configured such that each set of two pixels constitutes a picture element, the two pixels constituting each picture element respectively display two colors out of three primary colors, and four pixels that constitute two adjacent picture elements include three pixels that respectively display three primary colors.

With this configuration, a color image using three primary colors can be displayed by using a simple structure in which each picture element is made of two pixels, while suppressing the power consumption and flickering. Examples of the three primary colors include red, green, and blue.

In the display device of one embodiment of the present invention, it is preferable that the data line driver circuit supply data signals such that, among pixels that display the same color out of the plurality of pixels, polarities of data signals are reversed every m (m is an integer of 1 or greater) number of pixels that are closest to each other in a column direction, and are reversed every pixel of respective pixels that are closest to each other in a row direction.

In the display device of one embodiment of the present invention, it is preferable that the data line driver circuit supply data signals such that, among pixels that display the same color out of the plurality of pixels, polarities of data signals are reversed every pixel of respective pixels that are closest to each other in a column direction and in a row direction, respectively.

In the display device of one embodiment of the present invention, it is preferable that the data line driver circuit supply data signals such that, among pixels that display the same color out of the plurality of pixels, polarities of data signals are reversed every pair of two pixels closest to each other in a column direction, and are reversed every pixel of respective pixels that are closest to each other in a row direction.

In the display device of one embodiment of the present invention, it is preferable that the display panel include a switching element having a semiconductor layer made of an oxide semiconductor.

With this configuration, by using the switching element including a semiconductor layer made of the oxide semiconductor and having excellent ON characteristics and OFF characteristics in the display device, the frame frequency, or in other words, the refresh rate can be changed with ease.

In the display device of one embodiment of the present invention, it is preferable that the oxide semiconductor is IGZO.

With this configuration, by using IGZO as the oxide semiconductor in the display device, the frame frequency, or in other words, the refresh rate can be changed with ease.

It is preferable that the display device of one embodiment of the present invention be a liquid crystal display device.

As described above, a drive device of the display device of one embodiment of the present invention is a drive device that drives a display panel including a plurality of gate lines, a plurality of data lines disposed to intersect with the plurality of gate lines, and a plurality of pixels disposed for respective intersections of the plurality of gate lines and the plurality of data lines, the drive device including: a gate line driver circuit that supplies gate signals to the plurality of gate lines; a data line driver circuit that supplies data signals to the plurality of data lines; and a controller that controls the gate signal and the data signals by using an interlaced driving method, wherein the controller causes polarities of data signals applied to selected pixels that are to be selected in one field to be reversed every prescribed number of the selected pixels in a direction along the gate lines and to be reversed every prescribed number of the selected pixels in a direction along the data lines, respectively, and wherein, in the one field, the controller also causes the polarity of data signal applied to each pixel to be selected to be opposite to the polarity of the data signal that was applied to the pixel to be selected in an immediately preceding field to that one field, the immediately preceding field being where the pixel to be selected was previously selected.

With this configuration, the controller controls the gate line driver circuit and the data line driver circuit such that the gate signals and the data signals are supplied by using interlaced driving method in which one frame is constituted of a plurality of field. Therefore, with this configuration, power consumption can be reduced as compared with a configuration that does not use the interlaced driving method.

The controller controls the data line driver circuit such that the polarities of data signals applied to selected pixels that are to be selected in one field are reversed every prescribed number of the selected pixels in a direction along the gate lines and every prescribed number of the selected pixels in a direction along the data lines, respectively. With this configuration, the occurrence of flickering can be suppressed.

The controller also controls the data line driver circuit such that the polarity of data signal applied to each pixel to be selected in one field is made opposite to the polarity of the data signal that was applied to the pixel to be selected in an immediately preceding field to that one field, the immediately preceding field being where the pixel to be selected was previously selected. With this configuration, burn-in of the pixels can be prevented.

As described above, with the above-mentioned configuration, it is possible to suppress the occurrence of flickering while keeping power consumption low.

The selected pixels refer to the pixels that are defined by gate lines that receive the gate signal in one field. For example, when using the interlaced driving method in which one frame is constituted of a total of two fields, which are the first field of applying the gate signal to the odd gate lines and the second field of applying the gate signal to the even gate lines, selected pixels that are to be selected in the first field refer to the pixels that are defined by the odd gate lines, and selected pixels that are to be selected in the second field refer to the pixels that are defined by the even gate lines.

When the prescribed number in the direction along the gate lines is NG, and the prescribed number in the direction along the data lines is ND, the controller causes the polarities of data signals to be reversed every group of NG×ND selected pixels. When NG=1 and ND=1, for example, the controller conducts dot reverse driving for every selected pixel in respective fields that constitute one frame. When NG=2 and ND=2, the controller conducts polarity reversal driving for every 2×2 selected pixel group in respective fields that constitute one frame.

As described above, a driving method for a display device of one embodiment of the present invention is a driving method for driving a display panel including a plurality of gate lines, a plurality of data lines disposed to intersect with the plurality of gate lines, and a plurality of pixels disposed for respective intersections of the plurality of gate lines and the plurality of data lines, by using an interlaced driving method in which one frame is constituted of a plurality of fields, the method including: causing polarities of data signals applied to selected pixels that are to be selected in one field to be reversed every prescribed number of the selected pixels in a direction along the gate lines and to be reversed every prescribed number of the selected pixels in a direction along the data lines, respectively; and causing the polarity of data signal applied to each pixel to be selected in one field to be opposite to the polarity of the data signal that was applied to the pixel to be selected in an immediately preceding field to that one field, the immediately preceding field being where the pixel to be selected was previously selected.

In this driving method, the gate signals and the data signals are controlled to be supplied by using the interlaced driving method in which one frame is constituted of a plurality of frames. Therefore, with the above-mentioned driving method, power consumption can be reduced as compared with a configuration that does not use the interlaced driving method.

With the above-mentioned driving method, the polarities of data signals applied to selected pixels that are to be selected in one field are reversed every prescribed number of the selected pixels in a direction along the gate lines and every prescribed number of the selected pixels in a direction along the data lines, respectively. With this driving method, the occurrence of flickering can be suppressed.

With the above-mentioned driving method, the polarity of data signals applied to each pixel to be selected in one field is made opposite to the polarity of the data signal that was applied to the pixel to be selected in an immediately preceding field to that one field, the immediately preceding field being where the pixel to be selected was previously selected. With this configuration, burn-in of the pixels can be prevented.

As described above, with this driving method, it is possible to suppress the occurrence of flickering while keeping power consumption low.

The present invention is not limited to the embodiment described above, and various modifications can be made without departing from the scope of the claims. Therefore, embodiments obtained by appropriately combining the techniques disclosed in different embodiments are included in the technical scope of the present invention.

### INDUSTRIAL APPLICABILITY

The display device of one embodiment of the present invention can be suitably used for television receivers, personal computers, vehicle navigation systems, mobile phones, smartphones, digital cameras, digital video cameras, and the like.

### DESCRIPTION OF REFERENCE CHARACTERS

1 liquid crystal display device (display device)
2 display panel (liquid crystal display panel)
4 timing controller (controller)
6 scan line driver circuit (gate line driver circuit)
8 signal line driver circuit (data line driver circuit)
10 common electrode driver circuit
13 power generating circuit

1. A display device, comprising:
a display panel including a plurality of gate lines, a plurality of data lines disposed to intersect with the plurality of gate lines, and a plurality of pixels disposed for respective intersections of the plurality of gate lines and the plurality of data lines;
a gate line driver circuit that supplies gate signals to the plurality of gate lines;
a data line driver circuit that supplies data signals to the plurality of data lines; and
a controller that controls the gate signals and the data signals by using an interlaced driving method in which one frame is constituted of a plurality of fields,
wherein the controller causes polarities of data signals applied to pixels that are to be selected in one field to be reversed every prescribed number of such pixels in a direction along the gate lines and to be reversed every prescribed number of such pixels in a direction along the data lines, respectively, and
wherein, in said one field, the controller also causes the polarity of data signal applied to each pixel to be selected to be opposite to the polarity of the data signal that was last applied to the pixel.

2. The display device according to claim 1, wherein the plurality of pixels are configured such that each set of four pixels with two aligned along the gate lines and two aligned along the data lines constitutes a picture element, and the four pixels constituting each picture element respectively display three primary colors and one color that is made from at least one of the three primary colors.

3. The display device according to claim 1, wherein the plurality of pixels are configured such that each set of four pixels aligned along the gate lines constitutes a picture element, and the four pixels constituting each picture element respectively display three primary colors and one color that is different from any one of the three primary colors.

4. The display device according to claim 1, wherein the plurality of pixels are configured such that each set of three pixels aligned along the gate lines constitutes a picture element, and the three pixels constituting each picture element respectively display three primary colors.

5. The display device according to claim 1, wherein the plurality of pixels are configured such that each set of three pixels aligned along the data lines constitutes a picture element, and the three pixels constituting each picture element respectively display three primary colors.

6. The display device according to claim 1, wherein the plurality of pixels are configured such that each set of two pixels constitutes a picture element, the two pixels constituting each picture element respectively display two colors out of three primary colors, and four pixels that constitute two adjacent picture elements include three pixels that respectively display three primary colors.

7. The display device according to claim 1, wherein the data line driver circuit supplies data signals such that, among pixels that display the same color out of the plurality of pixels, polarities of data signals are reversed every m (m is an integer of 1 or greater) number of pixels that are closest to each other in a column direction, and are reversed every pixel of respective pixels that are closest to each other in a row direction.

8. The display device according to claim 1, wherein the data line driver circuit supplies data signals such that, among pixels that display the same color out of the plurality of pixels, polarities of data signals are reversed every pixel of respective pixels that are closest to each other in a column direction and in a row direction, respectively.

9. The display device according to claim 1, wherein the data line driver circuit supplies data signals such that, among pixels that display the same color out of the plurality of pixels, polarities of data signals are reversed every pair of two pixels closest to each other in a column direction, and are reversed every pixel of respective pixels that are closest to each other in a row direction.

10. The display device according to claim 1, further comprising a switching element that has a semiconductor layer made of an oxide semiconductor.

11. The display device according to claim 10, wherein the oxide semiconductor is IGZO.

12. The display device according to claim 1, wherein the display device is a liquid crystal display device.

13. A drive device that drives a display panel including a plurality of gate lines, a plurality of data lines disposed to intersect with the plurality of gate lines, and a plurality of pixels disposed for respective intersections of the plurality of gate lines and the plurality of data lines, the drive device comprising:
a gate line driver circuit that supplies gate signals to the plurality of gate lines;
a data line driver circuit that supplies data signals to the plurality of data lines; and
a controller that controls the gate signal and the data signals by using an interlaced driving method in which one frame is constituted of a plurality of fields,
wherein the controller causes polarities of data signals applied to pixels that are to be selected in one field to be reversed every prescribed number of such pixels in a direction along the gate lines and to be reversed every prescribed number of such pixels in a direction along the data lines, respectively, and
wherein, in said one field, the controller causes the polarity of data signal applied to each pixel to be selected to be opposite to the polarity of the data signal that was last applied to the pixel.

14. A driving method for driving a display panel including a plurality of gate lines, a plurality of data lines disposed to intersect with the plurality of gate lines, and a plurality of pixels disposed for respective intersections of the plurality of gate lines and the plurality of data lines, by using an interlaced driving method in which one frame is constituted of a plurality of fields, the method comprising:
causing polarities of data signals applied to pixels that are to be selected in one field to be reversed every prescribed number of such pixels in a direction along the gate lines and to be reversed every prescribed number of such pixels in a direction along the data lines, respectively, and
causing, in said one field, the polarity of data signal applied to each pixel to be selected to be opposite to the polarity of the data signal that was last applied to the pixel.
